(19) United States
(12) Patent Application Publication
(10) Pub. No.: US 2023/0321636 A1
(43) Pub. Date: Oct. 12, 2023

(54) OXIDATION CATALYST COMPRISING A PLATINUM GROUP METAL AND A BASE METAL OR METALLOID OXIDE

(71) Applicant: BASF Corporation, Florham Park, NJ (US)

(72) Inventors: Shiang Sung, Iselin, NJ (US); Jeffrey B. Hoke, Iselin, NJ (US); Markus Koegel, Heidelberg (DE)

(21) Appl. No.: 18/043,090

(22) PCT Filed: Aug. 27, 2021
(86) PCT No.: PCT/US2021/047912

§ 371 Date: Feb. 27, 2023

Related U.S. Application Data
(60) Provisional application No. 63/071,584, filed on Aug. 28, 2020.

(51) Int. Cl. B01J 23/44; B01J 23/10; B01J 23/34; B01J 23/889; B01J 37/02; F01N 3/28; B01D 53/94

(52) U.S. Cl. CPC B01J 23/44; B01J 23/10; B01J 23/34; B01J 23/8892; B01J 37/0228; B01J 37/0244; F01N 3/2828; B01D 53/944; F01N 2330/06; F01N 2510/0684; B01D 2258/012; B01D 2255/2065; B01D 2255/2061; B01D 2255/30; B01D 2255/1023; B01D 2255/1021; B01D 2257/702; B01D 2257/502

(57) ABSTRACT

The present disclosure relates to oxidation catalyst compositions comprising a platinum group metal (PGM) component comprising palladium, platinum, or a combination thereof; a first oxide chosen from oxides of cerium, silicon, iron, cobalt, zinc, chromium, molybdenum, nickel, tungsten, magnesium, antimony, tin, lead, yttrium, and combinations thereof; and a first refractory metal oxide support material; catalytic articles; and exhaust gas treatment systems, as well as methods of making and using such oxidation catalyst compositions.

This application claims the benefit of priority of U.S. Provisional Patent Application No. 63/071,584, filed Aug. 28, 2020, the contents of which are incorporated by reference herein in their entirety.

The present disclosure is directed to catalyst compositions suitable for treating exhaust gas streams of an internal combustion engine, such as, for example, a diesel engine, as well as to catalytic articles and systems incorporating such compositions and methods of using the same.

Environmental regulations for emissions of internal combustion engines are becoming increasingly stringent throughout the world. Operation of a lean-burn engine, for example, a diesel engine, provides the user with excellent fuel economy due to its operation at high air/fuel ratios under fuel-lean conditions. However, diesel engines also emit exhaust gas emissions containing particulate matter (PM), unburned hydrocarbons (HCs) and oxygen-containing hydrocarbon derivatives (e.g., formaldehyde), carbon monoxide (CO), and nitrogen oxides (NOₓ), wherein NOₓ describes various chemical species of nitrogen oxides, including nitrogen monoxide and nitrogen dioxide, among others. The two major components of exhaust particulate matter are the soluble organic fraction (SOF) and the insoluble carbonaceous soot fraction. The SOF condenses on the soot in layers and is generally derived from unburned diesel fuel and lubricating oils. The SOF can exist in diesel exhaust either as a vapor or as an aerosol (i.e., fine droplets of liquid condensate), depending on the temperature of the exhaust gas. Soot is predominately composed of particles of carbon.

Oxidation catalysts comprising a precious metal, such as one or more platinum group metals (PGMs), dispersed on a refractory metal oxide support, such as, for example, alumina, are known for use in treating the exhaust of diesel engines in order to convert hydrocarbon, oxygen-containing hydrocarbon derivatives, and carbon monoxide gaseous pollutants by catalyzing the oxidation of these pollutants to carbon dioxide and water. Such catalysts have been generally contained in units called diesel oxidation catalysts (DOCs), which are placed in the exhaust flow path from diesel engines to treat the exhaust before it vents to the atmosphere. Typically, the diesel oxidation catalysts are formed on ceramic or metallic substrates upon which one or more catalyst coating compositions are deposited. In addition to the conversion of gaseous HC and CO emissions and particulate matter (SOF portion), oxidation catalysts that contain one or more PGMs promote the oxidation of NO to NO₂. Catalysts are typically defined by their light-off temperature or the temperature at which 50% conversion is attained, also called T₅₀.

As regulations regarding vehicle emissions become more stringent, control of emissions during the cold start period has become increasingly important. While there are multiple harmful exhaust components that need to be considered, NOₓ is of particular interest in view of increasingly restrictive regulations. For the 2024 model year, NOₓ emissions regulations for heavy duty diesel vehicles require the tail pipe NOₓ to be less than or equal to 0.1 g/HP-Hr. Additionally, emissions regulations for the 2024 model year further require vehicles to meet formaldehyde emissions standards.

Various treatment methods have been used for the treatment of NOₓ-containing exhaust gas mixtures to decrease atmospheric pollution. One type of treatment involves a selective catalytic reduction (SCR) process wherein ammonia or an ammonia precursor is used as a reducing agent. In the selective reduction process, a high degree of nitrogen oxide removal can be achieved with a stoichiometric amount of reducing agent, resulting in the formation predominantly of nitrogen and steam.

Furthermore, catalysts used to treat the exhaust of internal combustion engines are less effective during periods of relatively low temperature operation, such as the initial cold-start period of engine operation, because the engine exhaust is not at a temperature sufficiently high enough for efficient catalytic conversion of noxious components in the exhaust (i.e., below 200° C.). At these low temperatures, exhaust gas treatment systems generally do not display sufficient catalytic activity for effectively treating hydrocarbons (HC), oxygen-containing hydrogen carbon derivatives (e.g., HCHO), nitrogen oxides (NOₓ) and/or carbon monoxide (CO) emissions. In general, catalytic components such as SCR catalyst components are very effective in converting NOₓ to N₂ at temperatures above 200° C. but do not exhibit sufficient activities in lower temperature regions (<200° C.), such as those found during cold-start or prolonged low-speed city driving. During the initial engine start up, covering the first 400 seconds of operation, the exhaust temperature at the entrance of the SCR is below 170° C., at which temperature the SCR is not yet fully functional. Consequently, nearly 70% of the system out NOₓ is emitted during the first 500 seconds of engine operation.

There presently exists a disconnect between DOC and SCR performance during cold start (i.e., NOₓ conversion performance before the SCR becomes functional), as the DOC becomes functional at a lower temperature than the SCR. One way to address this disconnect is to promote SCR performance at the low temperature end of the spectrum by enhancing NO₂/NOₓ performance of the DOC at a temperature below 250° C. A previous attempt to address these issues used a Mn-doped alumina to stabilize Pt, resulting in good NO₂/NOₓ performance. See, for example, U.S. Patent Application Publication Nos. US2015/0165422 and US2015/0165423 to BASF Corporation, which are incorporated herein by reference.

However, while the Mn-doped alumina/Pt catalyst disclosed therein offered stabilized NO₂/NOₓ performance, it did not offer the enhanced low temperature NO₂/NOₓ performance needed for the downstream SCR catalyst. Accordingly, there is a need in the art for catalyst compositions which enhance the DOC+SCR system performance during low temperature operation, and which effectively oxidize formaldehyde during low temperature operation.

The present disclosure generally provides oxidation catalyst compositions with enhanced hydrocarbon conversion and NO₂ formation relative to conventional oxidation catalysts, and which exhibit recovery from sulfur poisoning. Surprisingly, it has been found that, in certain embodiments of the present disclosure, oxidation catalyst compositions comprising a platinum group metal (PGM) comprising palladium and/or platinum, certain base metal or metalloid oxides, and a refractory metal oxide support material, promote NO₂ formation, exhibit enhanced hydrocarbon conversion (HC), and oxidize oxygen-containing hydrocarbon derivatives, such as formaldehyde, at temperatures comparable to those at which carbon monoxide (CO) is oxidized.

Accordingly, in a first aspect is provided an oxidation catalyst composition for use in an exhaust gas treatment system comprising a compression ignition internal combustion engine, the composition comprising a platinum group metal (PGM) component comprising palladium, platinum, or a combination thereof; a first oxide chosen from oxides of cerium, silicon, iron, cobalt, zinc, chromium, molybdenum, nickel, tungsten, magnesium, antimony, tin, lead, yttrium, and combinations thereof; and a first refractory metal oxide support material.

In some embodiments, the first oxide is chosen from oxides of yttrium and silicon.

In some embodiments, the oxidation catalyst composition comprises the first oxide in an amount by weight, on an oxide basis, from about 1% to about 40%, based on the weight of the first refractory metal oxide support material.

In some embodiments, the first refractory metal oxide support material comprises zirconia in an amount by weight from about 5% to about 99%, based on the weight of the first refractory metal oxide support material.

In some embodiments, the first refractory metal oxide support material comprises zirconia, titanium, or aluminum in an amount by weight from about 1% to about 99%, based on the weight of the first refractory metal oxide support material.

In some embodiments, the first refractory metal oxide support material comprises zirconia in an amount by weight from about 20% to about 99%, based on the weight of the first refractory metal oxide support material. In some embodiments, the zirconia is doped with lanthanum in an amount by weight from about 0.1% to about 40% (e.g., from about 1% to about 40%), on an oxide basis, based on the weight of the zirconia.

In some embodiments, the oxidation catalyst composition comprises the first oxide in an amount by weight, on an oxide basis, from about 1% to about 30%, or from about 5% to about 20%, based on the weight of the first refractory metal oxide support material.

In some embodiments, the palladium is loaded on the first refractory metal oxide support in an amount by weight from 0% to 10%, based on the weight of the first refractory metal oxide support; the platinum is loaded on the first refractory metal oxide support in an amount by weight from 0% to 10%, based on the weight of the first refractory metal oxide support; and at least one of the platinum or the palladium is present in an amount by weight of about 0.1% or greater, based on the weight of the first refractory metal oxide support.

In some embodiments, the PGM component comprises palladium and platinum. In some embodiments, a ratio of palladium to platinum by weight is from about 100 to about 0.01 (e.g., from about 100 to about 0.05). In some embodiments, a ratio of palladium to platinum by weight is from about 1 to about 0.01, from about 1 to about 0.05, or from about 0.5 to about 0.1.

In some embodiments, the PGM component consists essentially of palladium.

In some embodiments, the PGM component consists essentially of platinum.

In some embodiments, the oxidation catalyst composition further comprises a second refractory metal oxide support material. In some embodiments, the second refractory metal oxide support material comprises alumina, silica, zirconia, titania, ceria, or a combination thereof. In some embodiments, the second refractory metal oxide support material comprises alumina. In some embodiments, the second refractory metal oxide support material comprises zirconia. In some embodiments, the zirconia is doped with lanthanum in an amount by weight from about 0.1% to about 40% (e.g., from about 1% to about 40%), on an oxide basis, based on the weight of the zirconia.

In some embodiments, the first oxide is supported on the first refractory metal oxide support material, and the PGM component is supported on the second refractory metal oxide support material.

In some embodiments, the PGM component is supported on the second refractory metal oxide support material in an amount from about 0.5% to about 10% by weight, based on the weight of the second refractory metal oxide support material.

In some embodiments, the first oxide is supported on the first refractory metal oxide support material in an amount by weight, on an oxide basis, from about 1% to about 40%, based on the weight of the first refractory metal oxide support material; and the PGM component is supported on the second refractory metal oxide support material, wherein the second refractory metal oxide support material is chosen from (e.g., selected from the group consisting of) alumina, silica-doped alumina, titania, titania-doped alumina, zirconium doped alumina, zirconia, and zirconia doped with from about 0.1% to about 40% (e.g., from about 1% to about 40%) by weight of lanthana, based on the weight of the zirconia.

In some embodiments, the zirconia is doped with from about 0.1% to about 40% (e.g., from about 1% to about 40%) lanthana, based on the weight of the zirconia.

In some embodiments, the first refractory metal oxide support material further comprises ceria in an amount by weight from about 1% to about 50%, based on the weight of the first refractory metal oxide support material.

In some embodiments, the oxidation catalyst composition is substantially free of copper.

In another aspect is provided a catalytic article comprising a substrate having an inlet end and an outlet end defining an overall length, and a catalytic coating disposed on at least a portion thereof, the catalytic coating comprising a first washcoat and a second washcoat, wherein the first washcoat comprises a first oxide and a first refractory metal oxide support material, wherein the first oxide is chosen from oxides of cerium, silicon, iron, cobalt, zinc, chromium, molybdenum, nickel, tungsten, magnesium, antimony, tin, lead, yttrium, and combinations thereof, and the first oxide is supported on the first refractory metal oxide support material; and the second washcoat comprises a platinum group metal (PGM) component comprising palladium, platinum, or a combination thereof, and a second refractory metal oxide support material, wherein the PGM component is supported on the second refractory metal oxide support material.

In some embodiments, the catalytic article comprises the first oxide in an amount by weight, on an oxide basis, from about 1% to about 40%, based on the weight of the first refractory metal oxide support material. In some embodiments, the catalytic article comprises the first oxide in an amount by weight, on an oxide basis, from about 1% to about 30%, or from about 5% to about 20%, based on the weight of the first refractory metal oxide support material.

In some embodiments, the second refractory metal oxide support material comprises alumina, silica, zirconia, titania, ceria, or a combination thereof. In some embodiments, the second refractory metal oxide support material comprises alumina. In some embodiments, the second refractory metal oxide support material comprises zirconia. In some embodiments, the zirconia is doped with from about 0.1% to about 40% (e.g., from about 1% to about 40%) lanthanum oxide by weight, based on the total weight of the zirconia. In some embodiments, the second refractory metal oxide support material is chosen from (e.g., selected from the group consisting of) alumina, silica-doped alumina, titania, titania-doped alumina, zirconium doped alumina, zirconia, and zirconia doped with from about 0.1% to about 40% (e.g., from about 1% to about 40%) by weight of lanthana, based on the weight of the zirconia.

In some embodiments, the PGM component comprises a combination of platinum and palladium. In some embodiments, a ratio of palladium to platinum by weight is from about 100 to about 0.01 (e.g., from about 100 to about 0.05). In some embodiments, a ratio of palladium to platinum by weight is from about 1 to about 0.01, from about 1 to about 0.05, or from about 0.5 to about 0.1.

In some embodiments, the PGM component consists essentially of platinum.

In some embodiments, the PGM component consists essentially of palladium.

In some embodiments, the total PGM component loading on the catalytic article is from about 5 g/ft³ to about 200 g/ft³.

In some embodiments, the PGM is supported on the second refractory metal oxide support material in an amount from about 0.5% to about 5% by weight, based on the weight of the second refractory metal oxide support material.

In some embodiments, the first oxide is supported on the first refractory metal oxide support material in an amount by weight, on an oxide basis, from about 1% to about 30%, based on the weight of the first refractory metal oxide support material, wherein the first refractory metal oxide support material comprises alumina, titanium, or zirconia, wherein the zirconia is doped with from about 0.1% to about 40% lanthana (e.g., from about 1% to about 40%), based on the weight of the zirconia; the first refractory metal oxide support material further comprises ceria in an amount by weight from about 1% to about 50%, based on the weight of the first refractory metal oxide support material; and the PGM component is supported on the second refractory metal oxide support material, wherein the second refractory metal oxide support material is chosen from (e.g., selected from the group consisting of) alumina, silica-doped alumina, titania, titania-doped alumina, zirconium doped alumina, zirconia, and zirconia doped with from about 0.1% to about 40% (e.g., from about 1% to about 40%) by weight of lanthana, based on the weight of the zirconia.

In some embodiments, the first and second washcoats are substantially free of copper.

In some embodiments, the first washcoat is disposed directly on the substrate, and the second washcoat is disposed on at least a portion of the first washcoat. In some embodiments, the second washcoat is disposed directly on the substrate, and the first washcoat is disposed on at least a portion of the second washcoat. In some embodiments, the catalytic article has a zoned configuration, wherein the first washcoat is disposed directly on the substrate from the outlet end to a length from about 20% to about 100% of the overall length; and the second washcoat is disposed on the substrate from the inlet end to a length from about 20% to about 100% of the overall length. In some embodiments, the catalytic article has a zoned configuration, wherein the second washcoat is disposed directly on the substrate from the outlet end to a length from about 20% to about 100% of the overall length; and the first washcoat is disposed on the substrate from the inlet end to a length from about 20% to about 100% of the overall length.

In another aspect is provided an exhaust gas treatment system comprising the catalytic article as disclosed herein, wherein the catalytic article is downstream of and in fluid communication with a compression ignition internal combustion engine.

In a still further aspect is provided a method for treating an exhaust gas stream comprising hydrocarbons and/or carbon monoxide and/or NOₓ, the method comprising contacting the exhaust gas stream with the catalytic article or the exhaust gas treatment system, each as disclosed herein.

These and other features, aspects, and advantages of the disclosure will be apparent from a reading of the following detailed description together with the accompanying drawings, which are briefly described below. The disclosure includes any combination of two, three, four, or more of the above-noted embodiments, as well as combinations of any two, three, four, or more features or elements set forth in this disclosure, regardless of whether such features or elements are expressly combined in a specific embodiment description herein. This disclosure is intended to be read holistically such that any separable features or elements of the disclosed subject matter, in any of its various aspects and embodiments, should be viewed as intended to be combinable unless the context clearly dictates otherwise. Other aspects and advantages of the present disclosure will become apparent from the following.

### BRIEF DESCRIPTION OF THE DRAWINGS

In order to provide an understanding of certain embodiments of the disclosure, reference is made to the appended drawings, in which reference numerals refer to components of exemplary embodiments of the disclosure. The drawings are exemplary only, and should not be construed as limiting the present disclosure. The disclosure described herein is illustrated by way of example and not by way of limitation in the accompanying figures. For simplicity and clarity of illustration, features illustrated in the figures are not necessarily drawn to scale. For example, the dimensions of some features may be exaggerated relative to other features for clarity. Further, where considered appropriate, reference labels have been repeated among the figures to indicate corresponding or analogous elements.

FIG. 1A is a perspective view of a honeycomb-type substrate, which may comprise an oxidation catalyst composition in accordance with the present disclosure.

FIG. 1B is a partial cross-sectional view enlarged relative to FIG. 1A and taken along a plane parallel to the end faces of the substrate of FIG. 1A, which shows an enlarged view of a plurality of the gas flow passages shown in FIG. 1A, in an embodiment wherein the substrate is a flow-through substrate.

FIG. 2 is a cutaway view of a representative wall-flow filter.

FIGS. 3A, 3B, and 3C are non-limiting illustrations of possible coating configurations.

FIG. 4 is a schematic depiction of an embodiment of an emission treatment system in which a DOC catalyst article of the present disclosure is utilized.

FIG. 5 is a cartoon depiction of the composition loading for test articles according to certain embodiments of the disclosure.

FIG. 6 is a chart depicting NO₂/NOₓ yield at 300° C. and 250° C. for aged Pt/Pd (2/1) powder samples (9% La on Zr (reference); 10% Y on Zr).

FIG. 7 is a chart depicting NO₂/NOₓ yield at 300° C. and 250° C. for aged Pt/Pd (2/1) powder samples (9% La on Zr (reference); 10% Si/ZrO₂).

FIG. 8 is a chart depicting NO₂/NOₓ yield at 30° C. and 250° C. for aged Pt/Pd (2/1) powder samples (9% La on Zr (reference); Zr75/Mn24).

FIG. 9 is a chart depicting NO₂/NOₓ yield at 300° C. and 250° C. for aged Pt/Pd (2/1) powder samples (9/% La on Zr (reference); 10% Si on Ti).

FIG. 10 is a chart depicting NO₂/NOₓ yield at 300° C. and 250° C. for aged Pt/Pd (2/1) powder samples (9% La on Zr (reference); 5% Si on Al).

FIG. 11 is a chart depicting L/O temperature differential after S/de-S(HC₇₀, CO₅₀) versus before for inventive Example 24 (1% 2:1 Pt/Pd with 10% Y on ZrO₂) relative to reference Example 23 (1% 2:1 Pt/Pd on La/ZrO₂).

FIG. 12 is a chart depicting NO₂ differential after S/de-S versus before for inventive Example 24 (1% 2:1 Pt/Pd with 10% Y on ZrO₂) relative to reference Example 23 (1% 2:1 Pt/Pd on La/ZrO₂).

In some embodiments, the present disclosure generally provides an oxidation catalyst composition for use in an exhaust gas treatment system comprising a compression ignition internal combustion engine, the composition comprising a platinum group metal (PGM) component comprising palladium; a first oxide chosen from oxides of cerium, silicon, iron, cobalt, zinc, chromium, molybdenum, nickel, tungsten, magnesium, antimony, tin, lead, yttrium, and combinations thereof; and a first refractory metal oxide support material.

The presently disclosed subject matter now will be described more fully hereinafter. The disclosed subject matter may, however, be embodied in many different forms and should not be construed as limited to the embodiments set forth herein; rather, these embodiments are provided so that this disclosure will be thorough and complete, and will fully convey the scope of the disclosure to those skilled in the art.

### Definitions

As used herein, the articles “a” and “an” herein refer to one or to more than one (e.g., at least one) of the grammatical object. Any ranges cited herein are inclusive. The term “about” used throughout is used to describe and account for small fluctuations. For instance, “about” may mean the numeric value may be modified by +5%, +4%, +3%, +2%, +1%, ±0.5%, +0.4%, +0.3%, ±0.2%, +0.1% or +0.05%. All numeric values are modified by the term “about” whether or not explicitly indicated. Numeric values modified by the term “about” include the specific identified value. For example, “about 5.0” includes 5.0.

As used herein, the term “abatement” means a decrease in the amount, caused by any means.

As used herein, the term “associated” means, for instance, “equipped with”, “connected to”, or in “communication with”, for example, “electrically connected” or in “fluid communication with” or otherwise connected in a way to perform a function. The term “associated,” as used herein, may mean directly associated with or indirectly associated with, for instance, through one or more other articles or elements.

As used herein, “average particle size” is synonymous with D₅₀, meaning half of the population of particles has a particle size above this point, and half below. Particle size refers to primary particles. Particle size may be measured by laser light scattering techniques, with dispersions or dry powders, for example, according to ASTM method D4464. D₉₀ particle size distribution indicates that 90% of the particles (by number) have a Feret diameter below a certain size as measured by Scanning Electron Microscopy (SEM) or Transmission Electron Microscopy (TEM) for submicron size particles; and a particle size analyzer for the support-containing particles (micron size).

As used herein, the term “catalyst” refers to a material that promotes a chemical reaction. The catalyst includes the “catalytically active species” and the “carrier” that carries or supports the active species.

As used herein, the term “functional article” means an article comprising a substrate having a functional coating composition disposed thereon, in particular a catalyst and/or sorbent coating composition.

As used herein, the term “catalytic article” means an article comprising a substrate having a catalyst coating composition.

As used herein, “CSF” refers to a catalyzed soot filter, which is a wall-flow monolith. A wall-flow filter consists of alternating inlet channels and outlet channels, where the inlet channels are plugged on the outlet end and the outlet channels are plugged on the inlet end. A soot-carrying exhaust gas stream entering the inlet channels is forced to pass through the filter walls before exiting from the outlet channels. In addition to soot filtration and regeneration, a CSF may carry oxidation catalysts to oxidize CO and HC to CO₂ and H₂O, or to oxidize NO to NO₂ to accelerate downstream SCR catalysis or to facilitate the oxidation of soot particles at lower temperatures. A CSF, when positioned behind a LNT catalyst, can have a H₂S oxidation functionality to suppress H₂S emission during the LNT desulfation process. An SCR catalyst can also be, in some embodiments, coated directly onto a wall-flow filter, which is called a SCRoF.

As used herein, “DOC” refers to a diesel oxidation catalyst, which converts hydrocarbons and carbon monoxide in the exhaust gas of a diesel engine. In some embodiments, a DOC comprises one or more platinum group metals such as palladium and/or platinum and a refractory metal oxide support material.

As used herein, “LNT” refers to a lean NOₓ trap, which is a catalyst containing a platinum group metal, ceria, and an alkaline earth trap material suitable to adsorb NOₓ during lean conditions (for example, BaO or MgO). Under rich conditions, NOₓ is released and reduced to nitrogen.

As used herein, the phrase “catalyst system” refers to a combination of two or more catalysts, for example, a combination of a present oxidation catalyst and another catalyst, for example, a lean NOₓ trap (LNT), a catalyzed soot filter (CSF), or a selective catalytic reduction (SCR) catalyst. The catalyst system may alternatively be in the form of a washcoat in which the two or more catalysts are mixed together or coated in separate layers.

The term “configured” as used in the description and claims is intended to be an open-ended term, as are the terms “comprising” or “containing.” The term “configured” is not meant to exclude other possible articles or elements. The term “configured” may be equivalent to “adapted”.

In general, the term “effective” means, for example, from about 35% to 100% effective, for instance from about 40%, about 45%, about 50% or about 55% to about 60%, about 65%, about 70%, about 75%, about 80%, about 85%, about 90% or about 95%, regarding the defined catalytic activity or storage/release activity, by weight or by moles.

As used herein, “essentially free” means “little or no” or “no intentionally added,” and also having only trace and/or inadvertent amounts. For instance, in certain embodiments, “essentially free” means less than 2 wt. % (weight %), less than 1.5 wt. %, less than 1.0 wt. %, less than 0.5 wt. %, less than 0.25 wt. %, or less than 0.01 wt. %, based on the weight of the indicated total composition.

As used herein, the term “exhaust stream” or “exhaust gas stream” refers to any combination of flowing gas that may contain solid or liquid particulate matter. The stream comprises gaseous components and is, for example, exhaust of a lean burn engine, which may contain certain non-gaseous components such as liquid droplets, solid particulates, and the like. The exhaust gas stream of a combustion engine typically further comprises combustion products (CO₂ and H₂O), products of incomplete combustion (carbon monoxide (CO) and hydrocarbons (HC)), oxides of nitrogen (NOₓ), combustible and/or carbonaceous particulate matter (soot), and unreacted oxygen and nitrogen. As used herein, the terms “upstream” and “downstream” refer to relative directions according to the flow of an engine exhaust gas stream from an engine towards a tailpipe, with the engine in an upstream location and the tailpipe and any pollution abatement articles, such as filters and catalysts being downstream from the engine. The inlet end of a substrate is synonymous with the “upstream” end or “front” end. The outlet end is synonymous with the “downstream” end or “rear” end. An upstream zone is upstream of a downstream zone. An upstream zone may be closer to the engine or manifold, and a downstream zone may be further away from the engine or manifold.

The term “in fluid communication” is used to refer to articles positioned on the same exhaust line, i.e., a common exhaust stream passes through articles that are in fluid communication with each other. Articles in fluid communication may be adjacent to each other in the exhaust line. Alternatively, articles in fluid communication may be separated by one or more articles, also referred to as “washcoated monoliths.”

As used herein, the terms “nitrogen oxides” or “NOₓ” designate the oxides of nitrogen, such as, e.g., NO or NO₂.

As used herein, “impregnated” or “impregnation” refers to permeation of the catalytic material into the porous structure of the support material.

As used herein, the term “support” or “support material” refers to any high surface area material, usually a metal oxide material, upon which a catalytic precious metal is applied. The term “on a support” means “dispersed on”, “incorporated into”, “impregnated into”, “on”, “in”, “deposited on”, or otherwise associated with.

As used herein, the term “selective catalytic reduction” (SCR) refers to the catalytic process of reducing oxides of nitrogen to dinitrogen (N₂) using a nitrogenous reductant.

As used herein, the term “substrate” refers to the monolithic material onto which the catalyst composition, that is, catalytic coating, is disposed, typically in the form of a washcoat. In some embodiments, the substrates are flow-through monoliths and monolithic wall-flow filters. Flow-through and wall-flow substrates are taught, for example, in International Application Publication No. WO2016/070090, which is incorporated herein by reference. A washcoat is formed by preparing a slurry containing a specified solids content (e.g., 30-90% by weight) of catalyst in a liquid, which is then coated onto a substrate and dried to provide a washcoat layer. Reference to “monolithic substrate” means a unitary structure that is homogeneous and continuous from inlet to outlet. A washcoat is formed by preparing a slurry containing a certain solid content (e.g., 20%-90% by weight) of particles in a liquid vehicle, which is then coated onto a substrate and dried to provide a washcoat layer.

The terms “on” and “over” in reference to a coating layer may be used synonymously herein. The term “directly on” means in direct contact with. The disclosed articles are referred to in certain embodiments as comprising one coating layer “on” a second coating layer, and such language is intended to encompass embodiments with intervening layers, where direct contact between the coating layers is not required (i.e., “on” is not equated with “directly on”).

As used herein, the term “vehicle” means, for instance, any vehicle having an internal combustion engine and includes, but is not limited to, passenger automobiles, sport utility vehicles, minivans, vans, trucks, buses, refuse vehicles, freight trucks, construction vehicles, heavy equipment, military vehicles, farm vehicles, and the like.

As used herein, the term “washcoat” has its usual meaning in the art of a thin, adherent coating of a catalytic or other material applied to a substrate material, such as a honeycomb-type carrier member, which is sufficiently porous to permit the passage of the gas stream being treated. The washcoat can optionally comprise a binder chosen from silica, alumina, titania, zirconia, ceria, or a combination thereof. The loading of the binder is about 0.1 wt. % to 10 wt. %, based on the weight of the washcoat. As used herein and as described in Heck, Ronald and Farrauto, Robert, Catalytic Air Pollution Control, New York: Wiley-Interscience, 2002, pp. 18-19, a washcoat layer includes a compositionally distinct layer of material disposed on the surface of a monolithic substrate or an underlying washcoat layer. A substrate can contain one or more washcoat layers, and each washcoat layer can be different in some way (e.g., may differ in physical properties thereof such as, for example, particle size or crystallite phase) and/or may differ in the chemical catalytic functions.

Unless otherwise indicated, all parts and percentages are by weight. “Weight percent (wt %),” if not otherwise indicated, is based on an entire composition free of any volatiles, that is, based on dry solids content.

All methods described herein can be performed in any suitable order unless otherwise indicated herein or otherwise clearly contradicted by context. The use of any and all examples, or exemplary language (e.g., “such as”) provided herein, is intended merely to better illuminate the materials and methods and does not pose a limitation on the scope unless otherwise claimed. No language in the specification should be construed as indicating any non-claimed element is essential to the practice of the disclosed materials and methods.

All U.S. patent applications, published patent applications, and patents referred to herein are hereby incorporated by reference.

### Non-Limiting Example Embodiments:

Without limitation, some non-limiting embodiments of the disclosure include:

1. An oxidation catalyst composition comprising:
a platinum group metal (PGM) component comprising palladium, platinum, or a combination thereof;
a first oxide chosen from oxides of cerium, silicon, iron, cobalt, zinc, chromium, molybdenum, nickel, tungsten, magnesium, antimony, tin, lead, yttrium, and combinations thereof, and
a first refractory metal oxide support material.
   2. The oxidation catalyst composition of Embodiment 1, wherein the first oxide is chosen from oxides of yttrium and silicon.
   3. The oxidation catalyst composition of Embodiment 1 or 2, comprising the first oxide in an amount by weight, on an oxide basis, from about 1% to about 90%, based on the weight of the first refractory metal oxide support material.
   4. The oxidation catalyst composition of any one of Embodiments 1-3, wherein the first oxide is supported on the first refractory metal oxide support material.
   5. The oxidation catalyst composition of any one of Embodiments 1-4, wherein the first refractory metal oxide support material comprises zirconia, titanium, or aluminum in an amount by weight from about 1% to about 99%.
   6. The oxidation catalyst composition of any one of Embodiments 1-4, wherein the first refractory metal oxide support material comprises alumina, silica, ceria, titanium oxide, silica-doped alumina, silica-titania, silica-zirconia, yttrium-zirconium, manganese-zirconium, tungsten-titania, zirconia-titania, zirconia-ceria, zirconia-alumina, manganese-alumina, lanthanum-zirconia-alumina, magnesium-alumina oxide, zirconia doped with from about 0.1% to about 40% (e.g., from about 1% to about 40%) by weight of lanthana, and combinations thereof.
   7. The oxidation catalyst composition of any one of Embodiments 1 or 4-6, wherein:
the first oxide is an oxide of ceria, and
the ceria is present in an amount up to about 99% by weight, based on the weight of the first refractory metal oxide support material.
   8. The oxidation catalyst composition of any one of Embodiments 1 or 4-6, wherein:
the first oxide is an oxide of yttrium, and
the yttrium is present in an amount up to about 99% by weight, based on the weight of the first refractory metal oxide support material.
   9. The oxidation catalyst composition of any one of Embodiments 1 or 4-6, wherein:
the first oxide is an oxide of silicon, and
the silicon is present in an amount up to about 99% by weight, based on the weight of the first refractory metal oxide support material.
   10. The oxidation catalyst composition of any one of Embodiments 1-9, wherein:
the palladium is loaded on the first refractory metal oxide support in an amount by weight from about 0% to about 10%, based on the weight of the first refractory metal oxide support;
the platinum is loaded on the first refractory metal oxide support in an amount by weight from about 0% to about 10%, based on the weight of the first refractory metal oxide support; and
wherein at least one of the platinum or the palladium is present in an amount by weight of about 0.1% or greater, based on the weight of the first refractory metal oxide support material.
   11. The oxidation catalyst composition of any one of Embodiments 1-10, wherein the PGM component comprises a combination of platinum and palladium.
   12. The oxidation catalyst composition of Embodiment 11, wherein a ratio of palladium to platinum by weight is from about 100 to about 0.01.
   13. The oxidation catalyst composition of Embodiment 11, wherein a ratio of palladium to platinum by weight is from about 1 to about 0.01.
   14. The oxidation catalyst composition of any one of Embodiments 1-13, further comprising a second refractory metal oxide support material.
   15. The oxidation catalyst composition of Embodiment 14, wherein the second refractory metal oxide support material comprises alumina, silica, zirconia, titania, ceria, silica-doped alumina, silica-titania, silica-zirconia, yttrium-zirconium, manganese-zirconium, tungsten-titania, zirconia-titania, zirconia-ceria, zirconia-alumina, manganese-alumina, lanthanum-zirconia, lanthanum-zirconia-alumina, magnesium-alumina oxide, or a combination thereof.
   16. The oxidation catalyst composition of Embodiment 14 or 15, wherein the second refractory metal oxide support material comprises a base metal oxide chosen from oxides of cerium, iron, cobalt, zinc, chromium, molybdenum, nickel, tungsten, copper, magnesium, antimony, tin, lead, yttrium, and combinations thereof.
   17. The oxidation catalyst composition of Embodiment 14, wherein the PGM component is supported on the second refractory metal oxide support material in an amount by weight from about 0.1% to about 10%, based on the weight of the second refractory metal oxide support material.
   18. The oxidation catalyst composition of Embodiment 14, wherein the second refractory metal oxide support material comprises alumina or zirconia.
   19. The oxidation catalyst composition of Embodiment 18, wherein the zirconia in the second refractory metal oxide support material is doped with lanthanum in an amount by weight from about 0.1% to about 40% on an oxide basis, based on the weight of the zirconia.
   20. The oxidation catalyst composition of any one of Embodiments 14-19, wherein the first oxide is supported on the first refractory metal oxide support material, and the PGM component is supported on the second refractory metal oxide support material.
   21. The oxidation catalyst composition of Embodiment 20, wherein the PGM component is supported on the second refractory metal oxide support material in an amount from about 0.1% to about 10% by weight, based on the weight of the second refractory metal oxide support material.
   22. The oxidation catalyst composition of Embodiment 14, wherein:
the first oxide is supported on the first refractory metal oxide support material in an amount by weight, on an oxide basis, from about 1% to about 40%, based on the weight of the first refractory metal oxide support material; and
the PGM component is supported on the second refractory metal oxide support material, wherein the second refractory metal oxide support material is chosen from alumina, silica-doped alumina, titania, titania-doped alumina, zirconium doped alumina, zirconia, and zirconia doped with from about 0.1% to about 40% (e.g., from about 1% to about 40%) by weight of lanthana, based on the weight of the zirconia.
   23. The oxidation catalyst composition of Embodiment 22, wherein the first oxide is chosen from oxides of yttrium and silicon.
   24. The oxidation catalyst composition of Embodiment 22, wherein the first refractory metal oxide support material comprises ceria in an amount by weight from about 1% to about 50%, based on the weight of the first refractory metal oxide support material.
   25. The oxidation catalyst composition of any one of Embodiments 1-24, wherein the oxidation catalyst composition is substantially free of copper.
   26. A catalytic article comprising a substrate having an inlet end and an outlet end defining an overall length, and a catalytic coating disposed on at least a portion thereof, the catalytic coating comprising a first washcoat and a second washcoat, wherein:
the first washcoat comprises a first oxide and a first refractory metal oxide support material, wherein the first oxide is chosen from oxides of cerium, silicon, iron, cobalt, zinc, chromium, molybdenum, nickel, tungsten, magnesium, antimony, tin, lead, yttrium, and combinations thereof; and the first oxide is supported on the first refractory metal oxide support material; and
the second washcoat comprises a platinum group metal (PGM) component comprising palladium, platinum, or a combination thereof, and a second refractory metal oxide support material, wherein the PGM component is supported on the second refractory metal oxide support material.
   27. The catalytic article of Embodiment 26, comprising the first oxide in an amount by weight, on an oxide basis, from about 1% to about 40%, based on the weight of the first refractory metal oxide support material.
   28. The catalytic article of Embodiment 26, wherein the first oxide is an oxide of yttrium, and the yttrium is present in an amount up to about 99% by weight, based on the weight of the first refractory metal oxide support material.
   29. The catalytic article of Embodiment 26, wherein the first oxide is an oxide of silicon, and the silicon is present in an amount up to about 99% by weight, based on the weight of the first refractory metal oxide support material.
   30. The catalytic article of any one of Embodiments 26-29, wherein the first refractory metal oxide support material comprises zirconia, titanium, or aluminum in an amount by weight from about 1% to about 99%.
   31. The catalytic article of any one of Embodiments 26-29, wherein the first refractory metal oxide support material comprises alumina.
   32. The catalytic article of any one of Embodiments 26-29, wherein the first refractory metal oxide support material comprises zirconia doped with from about 0.1% to about 40% (e.g., from about 1% to about 40%) lanthanum oxide by weight, based on the total weight of the zirconia.
   33. The catalytic article of any one of Embodiments 26-32, wherein the second refractory metal oxide support material comprises alumina, silica, zirconia, titania, ceria, or a combination thereof.
   34. The catalytic article of any one of Embodiments 26-32, wherein the second refractory metal oxide support material comprises manganese.
   35. The catalytic article of any one of Embodiments 26-32, wherein the second refractory metal oxide support material comprises alumina or zirconia.
   36. The catalytic article of Embodiment 35, wherein the zirconia in the second refractory metal oxide support material is doped with from about 0.1% to about 40% lanthanum oxide by weight, based on the total weight of the zirconia.
   37. The catalytic article of any one of Embodiments 26-32, wherein the second refractory metal oxide support material is chosen from alumina, silica-doped alumina, titania, titania-doped alumina, zirconium doped alumina, zirconia, and zirconia doped with from about 1 to about 40% by weight of lanthana, based on the weight of the zirconia.
   38. The catalytic article of any one of Embodiments 26-37, wherein the PGM component comprises a combination of platinum and palladium.
   39. The catalytic article of Embodiment 38, wherein a ratio of palladium to platinum by weight is from about 100 to about 0.01.
   40. The catalytic article of Embodiment 38, wherein a ratio of palladium to platinum by weight is from about 1 to about 0.01.
   41. The catalytic article of any one of Embodiments 26-40, wherein the total PGM component loading on the catalytic article is from about 5 g/ft³ to about 200 g/ft.
   42. The catalytic article of any one of Embodiments 26-41, wherein the PGM is supported on the second refractory metal oxide support material in an amount from about 0.5% to about 10% (e.g., from about 0.5% to about 5%) by weight, based on the weight of the second refractory metal oxide support material.
   43. The catalytic article of Embodiment 26, wherein:
the first oxide is supported on the first refractory metal oxide support material in an amount by weight, on an oxide basis, from about 1% to about 30%, based on the weight of the first refractory metal oxide support material, wherein the first refractory metal oxide support material comprises alumina, titanium, or zirconia, wherein the zirconia is doped with from about 0.1% to about 40% lanthana, based on the weight of the zirconia;
the first refractory metal oxide support material optionally further comprises ceria in an amount by weight from about 1% to about 50%, based on the weight of the first refractory metal oxide support material; and
the PGM component is supported on the second refractory metal oxide support material, wherein the second refractory metal oxide support material is chosen from alumina, silica-doped alumina, titania, titania-doped alumina, zirconium doped alumina, zirconia, and zirconia doped with from about 0.1% to about 40% by weight of lanthana, based on the weight of the zirconia.
   44. The catalytic article of any one of Embodiments 26-43, wherein the first and second washcoats are substantially free of copper.
   45. The catalytic article of any one of Embodiments 26-44, wherein the first washcoat is disposed directly on the substrate, and the second washcoat is disposed on at least a portion of the first washcoat.
   46. The catalytic article of any one of Embodiments 26-44, wherein the second washcoat is disposed directly on the substrate, and the first washcoat is disposed on at least a portion of the second washcoat.
   47. The catalytic article of any one of Embodiments 26-44, wherein the catalytic article has a zoned configuration, wherein the first washcoat is disposed directly on the substrate from the outlet end to a length from about 20% to about 100% of the overall length; and the second washcoat is disposed on the substrate from the inlet end to a length from about 20% to about 100% of the overall length.
   48. The catalytic article of any one of Embodiments 26-44, wherein the catalytic article has a zoned configuration, wherein the second washcoat is disposed directly on the substrate from the outlet end to a length from about 20% to about 100% of the overall length; and the first washcoat is disposed on the substrate from the inlet end to a length from about 20% to about 100% of the overall length.
   49. A catalytic article comprising a substrate having an inlet end and an outlet end defining an overall length, and a catalytic coating disposed on at least a portion thereof, the catalytic coating comprising a first washcoat, a second washcoat, and a third washcoat, wherein:
the first washcoat comprises a first oxide and a first refractory metal oxide support material, wherein the first oxide is chosen from oxides of yttrium and silicon, and the first oxide is supported on the first refractory metal oxide support material;
the second washcoat comprises a base metal oxide component comprising ceria, zirconia, lanthanum oxide, copper oxide, or a combination thereof, and a second refractory metal oxide support material, wherein the base metal oxide component is supported on the second refractory metal oxide support material; and
the third washcoat comprises a platinum group metal (PGM) component comprising palladium, platinum, or a combination thereof, and a third refractory metal oxide support material, wherein the PGM component is supported on the third refractory metal oxide support material.
   50. The catalytic article of Embodiment 49, wherein the first refractory metal oxide support material comprises zirconia, titanium, or aluminum in an amount by weight from about 1% to about 99%.
   51. The catalytic article of Embodiment 49 or 50, wherein the second refractory metal oxide support material comprises alumina, silica, zirconia, titania, ceria, silica-doped alumina, titania, titania-doped alumina, zirconium doped alumina, zirconia, silica-titania, silica-zirconia, yttrium-zirconium, manganese-zirconium, tungsten-titania, zirconia-titania, zirconia-ceria, zirconia-alumina, manganese-alumina, lanthanum-zirconia, lanthanum-zirconia-alumina, magnesium-alumina oxide, or a combination thereof.
   52. The catalytic article of Embodiment 49 or 50, wherein the second refractory metal oxide support material comprises alumina.
   53. The catalytic article of Embodiment 49 or 50, wherein the second refractory metal oxide support material comprises silica-doped alumina.
   54. The catalytic article of Embodiment 49 or 50, wherein the second refractory metal oxide support material comprises zirconia.
   55. The catalytic article of Embodiment 54, wherein the zirconia in the second refractory metal oxide support material is doped with from about 0.1% to about 40% lanthanum oxide by weight, based on the total weight of the zirconia.
   56. The catalytic article of any one of Embodiments 49-55, wherein the third refractory metal oxide support material comprises alumina, silica, zirconia, titania, ceria, silica-doped alumina, titania, titania-doped alumina, zirconium doped alumina, zirconia, silica-titania, silica-zirconia, tungsten-titania, zirconia-titania, zirconia-ceria, zirconia-alumina, lanthanum-zirconia, lanthanum-zirconia-alumina, magnesium-alumina oxide, or a combination thereof.
   57. The catalytic article of any one of Embodiments 49-56, wherein the PGM component comprises a combination of platinum and palladium.
   58. The catalytic article of any one of Embodiments 49-57, wherein the first washcoat is disposed directly on the substrate, and the second washcoat is disposed on at least a portion of the first washcoat.
   59. The catalytic article of any one of Embodiments 49-57, wherein the second washcoat is disposed directly on the substrate, and the first washcoat is disposed on at least a portion of the second washcoat.
   60. The catalytic article of any one of Embodiments 49-57, wherein the first washcoat is disposed directly on the substrate, the second washcoat is disposed on at least a portion of the first washcoat, and the third washcoat is disposed on at least a portion of the second washcoat.
   61. The catalytic article of any one of Embodiments 49-57, wherein the third washcoat is disposed directly on the substrate, the second washcoat is disposed on at least a portion of the third washcoat, and the first washcoat is disposed on at least a portion of the second washcoat.
   62. The catalytic article of any one of Embodiments 49-57, wherein the first washcoat is disposed directly on the substrate, the third washcoat is disposed on at least a portion of the first washcoat, and the second washcoat is disposed on at least a portion of the third washcoat.
   63. The catalytic article of any one of Embodiments 49-57, wherein the second washcoat is disposed directly on the substrate, the third washcoat is disposed on at least a portion of the second washcoat, and the first washcoat is disposed on at least a portion of the third washcoat.
   64. The catalytic article of any one of Embodiments 49-57, wherein the second washcoat is disposed directly on the substrate, the first washcoat is disposed on at least a portion of the second washcoat, and the third washcoat is disposed on at least a portion of the first washcoat.
   65. The catalytic article of any one of Embodiments 49-57, wherein the catalytic article has a zoned configuration, wherein:
the first washcoat is disposed directly on the substrate from the outlet end to a length from about 20% to about 100% of the overall length;
the second washcoat is disposed on the substrate from the inlet end to a length from about 20% to about 100% of the overall length; and
the third washcoat is disposed on the substrate from the inlet end to a length from about 20% to about 100% of the overall length.
   66. An exhaust gas treatment system comprising the catalytic article of any one of Embodiments 26-65, wherein the catalytic article is downstream of and in fluid communication with a compression ignition internal combustion engine.
   67. A method for treating an exhaust gas stream comprising hydrocarbons and/or carbon monoxide and/or NON, the method comprising contacting the exhaust gas stream with the catalytic article of any one of Embodiments 26-65, or the exhaust gas treatment system of Embodiment 66.

### Oxidation Catalyst Composition

As described herein above, the disclosure generally provides an oxidation catalyst composition comprising a refractory metal oxide support material, a platinum group metal (PGM) component, and a first oxide chosen from oxides of cerium, silicon, iron, cobalt, zinc, chromium, molybdenum, nickel, tungsten, magnesium, antimony, tin, lead, yttrium, and combinations thereof. Each of the individual components of the composition are described further herein below.

### Refractory Metal Oxide Support

The oxidation catalyst composition as disclosed herein comprises a refractory metal oxide support material. As used herein, “refractory metal oxide” refers to porous metal-containing oxide materials exhibiting chemical and physical stability at high temperatures, such as the temperatures associated with diesel engine exhaust. Exemplary refractory metal oxides include, but are not limited to, alumina, silica, zirconia, titania, ceria, and physical mixtures or chemical combinations thereof, including atomically-doped combinations and including high surface area or activated compounds such as activated alumina. In some embodiments, the refractory metal oxide support comprises alumina, silica, ceria, titanium oxide, silica-doped alumina, silica-titania, silica-zirconia, yttrium-zirconium, manganese-zirconium, tungsten-titania, zirconia-titania, zirconia-ceria, zirconia-alumina, manganese-alumina, lanthanum-zirconia, lanthanum-zirconia-alumina, magnesium-alumina oxide, and combinations thereof. Exemplary aluminas include large pore boehmite, gamma-alumina, and delta/theta alumina. Useful commercial aluminas include activated aluminas, such as high bulk density gamma-alumina, low or medium bulk density large pore gamma-alumina, and low bulk density large pore boehmite and gamma-alumina.

High surface area refractory oxide supports, such as alumina support materials, also referred to as “gamma alumina” or “activated alumina,” typically exhibit a BET surface area in excess of 60 m²/g, often up to about 200 m²/g or higher. Such activated alumina is usually a mixture of the gamma and delta phases of alumina, but may also contain substantial amounts of eta, kappa and theta alumina phases. As used herein, “BET surface area” has its usual meaning of referring to the Brunauer, Emmett, Teller method for determining surface area by N₂ adsorption. In some embodiments, the refractory metal oxide support material (e.g., activated alumina) has a specific surface area of 60 m²/g to 350 m²/g, for example, from about 90 m²/g to about 250 m²/g.

In some embodiments, the refractory metal oxide support material comprises alumina (Al₂O₃), silica (SiO₂), zirconia (ZrO₂), titania (TiO₂), ceria (CeO₂), or physical mixtures or chemical combinations thereof. In certain embodiments, refractory metal oxide supports useful in the oxidation catalyst composition disclosed herein are doped with another metal oxide, including, but not limited to, silica (SiO₂), ceria (CeO₂), titania (TiO₂), or lanthana (La₂O₃). In some embodiments, the refractory metal oxide support is selected from doped materials, such as Si-doped alumina materials (including, but not limited to 1-10% SiO₂—Al₂O₃), doped titania materials, such as Si-doped titania materials (including, but not limited to, 1-10% SiO₂—TiO₂) or doped zirconia materials, such as Si-doped ZrO₂ (including, but not limited to, 5-30% SiO₂—ZrO₂). Accordingly, in some embodiments, the refractory metal oxide support material comprises SiO₂-doped Al₂O₃, SiO₂-doped TiO₂, or SiO₂-doped ZrO₂ (including, but not limited to 5-30% SiO₂—ZrO₂).

In some embodiments, the refractory metal oxide support material comprises zirconia. In some embodiments, the zirconia is doped with one or more dopants. In some embodiments, the refractory metal oxide support material comprises zirconia in an amount of from about 5% to about 99% (i.e., the total amount of dopants present is from about 1 to about 95%). In some embodiments, the refractory metal oxide support material comprises zirconia in an amount of from about 20% to about 99% (i.e., the total amount of dopants present is from about 1% to about 80%). In some embodiments, the zirconia is doped with lanthana. In some embodiments, the refractory metal oxide support material comprises zirconia doped with from about 0.1% to about 40% (e.g., from about 1% to about 40%) La₂O₃. In some embodiments, the zirconia is doped with from about 1%, about 2%, about 3%, about 4%, about 5%, about 6%, about 7%, about 8%, about 9%, or about 10%, to about 15%, about 20%, about 25%, about 30%, about 35%, or about 40% lanthana by weight, based on the weight of the zirconia. In some embodiments, the zirconia is doped with from about 1% to about 10% lanthana. In some embodiments, the zirconia is doped with about 9% lanthana.

The dopant metal oxide(s) can be introduced using, for example, an incipient wetness impregnation technique. In some embodiments, the metal oxide may be present in the doped refractory metal oxide support material in the form of a mixed oxide, meaning the metal oxides are covalently bound with one another through shared oxygen atoms.

The oxidation catalyst composition may comprise any of the above named refractory metal oxides and in any amount. For example, refractory metal oxides in the catalyst composition may comprise from about 15 wt %, about 20 wt %, about 25 wt/o, about 30 wt %, about 35 wt %, about 40%, about 45%, or about 50 wt %, to about 55 wt %, about 60 wt %, about 65 wt %, about 70 wt %, about 75 wt %, about 80 wt %, about 85 wt %, about 90 wt %, about 95 wt %, or about 99 wt %, based on the total dry weight of the catalyst composition.

Reference is made herein to a “first” refractory metal oxide support material, and in some embodiments, a “second” refractory metal oxide support material, so as to distinguish each refractory metal oxide support material. The first and second refractory metal oxide support materials may be the same or different. In some embodiments, the first and second refractory, metal oxide support material are the same. In other embodiments, the first and second refractory metal oxide support materials are different.

In some embodiments, the first refractory metal oxide support material comprises zirconia. In some embodiments, the first refractory metal oxide support comprises zirconia doped with lanthanum oxide. In some embodiments, the first refractory metal oxide support material comprises zirconia doped with from 1-40% lanthanum oxide. In some embodiments, the first refractory metal oxide support material comprises zirconia doped with from 1-10% lanthanum oxide. In some embodiments, the first refractory metal oxide support material comprises zirconia doped with about 9% lanthanum oxide.

In some embodiments, the first refractory metal oxide support material is substantially free of lanthanum.

In some embodiments, the second refractory metal oxide support material comprises manganese.

In some embodiments, the second refractory metal oxide support material comprises alumina, silica, zirconia, titania, ceria, silica-doped alumina, silica-titania, silica-zirconia, yttrium-zirconium, manganese-zirconium, tungsten-titania, zirconia-titania, zirconia-ceria, zirconia-alumina, manganese-alumina, lanthanum-zirconia, lanthanum-zirconia-alumina, magnesium-alumina oxide, or a combination thereof. In some embodiments, the second refractory metal oxide support material comprises alumina, silica, zirconia, titania, ceria, or a combination thereof. In one or more embodiments, the second refractory metal oxide support is chosen from (e.g., selected from the group consisting of) gamma alumina, silica doped alumina, ceria doped alumina, and titania doped alumina. In some embodiments, the second refractory metal oxide support material is chosen from (e.g., selected from the group consisting of) alumina, silica-doped alumina, titania, titania-doped alumina, zirconium doped alumina, zirconia, and zirconia doped with from about 0.1% to about 40% (e.g., from about 1% to about 40%) by weight of lanthana, based on the weight of the zirconia. In some embodiments, the second refractory metal oxide support material is chosen from (e.g., selected from the group consisting of) gamma alumina and alumina doped with from about 1% to about 10% by weight of SiO₂. In some embodiments, the second refractory metal oxide support material is alumina doped with from about 1% to about 10% by weight of SiO₂, for example, about 1%, about 2%, about 3%, about 4%, about 5%, about 6%, about 7%, about 8%, about 9%, or about 10% by weight of SiO₂. In some embodiments, the second refractory metal oxide support material is alumina.

In some embodiments, the second refractory metal oxide support material comprises zirconia. In some embodiments, the second refractory metal oxide support material is chosen from (e.g., selected from the group consisting of) alumina, silica-doped alumina, zirconia, and zirconia doped with from about 0.1% to about 40% (e.g., from about 1% to about 40%) by weight of lanthana, based on the weight of the zirconia. In some embodiments, the second refractory metal oxide support is zirconia doped with lanthanum oxide. In some embodiments, the second refractory metal oxide support material is zirconia doped with from 1-40% lanthanum oxide. In some embodiments, the second refractory metal oxide support material is zirconia doped with from 1-10% lanthanum oxide. In some embodiments, the second refractory metal oxide support material is zirconia doped with about 9% lanthanum oxide. In some embodiments, the first and second refractory metal oxide support material both comprise zirconia doped with from about 1-10% lanthanum oxide. In some embodiments, the first refractory metal oxide support material comprises zirconia doped with from about 1-10% lanthanum oxide, and the second refractory metal oxide support material is alumina.

In some embodiments, the second refractory metal oxide support material is substantially free of lanthanum.

### Platinum Group Metal (PGM) Component

The oxidation catalyst composition as described herein comprises a platinum group metal (PGM) component. PGMs include platinum (Pt), palladium (Pd), ruthenium (Ru), rhodium (Rh), osmium (Os), iridium (Ir), gold (Au), and mixtures thereof. The PGM component can include the PGM in any valence state. As used herein, the term “PGM component” refers both to a catalytically active form of the respective PGM, as well as the corresponding PGM compound, complex, or the like which, upon calcination or use of the catalyst, decomposes or otherwise converts to the catalytically active form, usually the metal or the metal oxide. The PGM may be in metallic form, with zero valence (“PGM(0)”), or the PGM may be in an oxide form (e.g., including, but not limited to, platinum or an oxide thereof). The amount of PGM(0) present can be determined using ultrafiltration, followed by Inductively Coupled Plasma/Optical Emission Spectrometry (ICP-OES), or by X-Ray photoelectron spectroscopy (XPS).

In some embodiments, the PGM component comprises platinum, palladium, or a combination thereof. In some embodiments, the PGM component is palladium. In some embodiments, the PGM component is platinum. In some embodiments, the PGM component is a combination of palladium and platinum. Exemplary weight ratios for such Pd/Pt combinations include, but are not limited to, weight ratios of from about 100 to about 0.01 Pd:Pt, for example, about 100:1, about 50:1, about 40:1, 30:1, about 25:1, about 20:1, about 15:1, about 10:1, about 5:1, about 4:1, about 3:1, about 2:1, about 1:1, about 1:2, about 1:5, about 1:10, or about 1:20 Pd/Pt. In some embodiments, the Pd/Pt weight ratio is about 100. In some embodiments, the ratio of palladium to platinum by weight is from about 1 to about 0.01, from about 1 to about 0.05, or from about 0.5 to about 0.1. In each case, the weight ratio is on an elemental (metal) basis.

The PGM component is supported (e.g., impregnated) on a refractory metal oxide support material as described herein above. The PGM component may be present in an amount in the range of about 0.01% to about 20% (e.g., about 0.1% to about 10%, about 0.5% to about 5%) by weight on a metal basis, based on the total weight of the refractory metal oxide support material including the supported PGM. The oxidation catalyst composition may comprise the PGM, for example, Pd or Pt/Pd at from about 0.1 wt %, about 0.5 wt %, about 1.0 wt %, about 1.5 wt % or about 2.0 wt %, to about 3 wt %, about 5 wt %, about 7 wt %, about 9 wt %, about 10 wt %, about 12 wt %, about 15 wt %, about 16 wt %, about 17 wt %, about 18 wt %, about 19 wt %, or about 20 wt %, based on the total weight of the refractory metal oxide support material, including the supported PGM.

In some embodiments, the platinum group metal component is supported on the second refractory metal oxide support material. In some embodiments, the PGM component is platinum, palladium, or a combination thereof, and the PGM is supported on the second refractory metal oxide support material in an amount from about 0.5 to about 5% by weight, based on the weight of the second refractory metal oxide support material. In some embodiments, the PGM is supported on the second refractory metal oxide support material in an amount of about 2% by weight, based on the weight of the second refractory metal oxide support material.

In some embodiments, the total PGM component loading on the catalytic article is from about 5 g/ft³ to about 200 g/ft³.

### First Oxide

In some embodiments, an oxidation catalyst composition as disclosed herein further comprises a first oxide, which may be a base metal oxide or a metalloid oxide. As used herein, “base metal oxide” refers to an oxide compound comprising a transition metal or lanthanide series metal that is catalytically active for oxidation of one or more exhaust gas components. As used herein, “metalloid oxide” refers to an oxide compound comprising a metalloid (e.g., silicon) that is catalytically active for oxidation of one or more exhaust gas components. For ease of reference herein, concentrations of first oxide materials are reported in terms of elemental metal concentration rather than the oxide form. Generally, at least a portion of the first oxide is disposed on or in the refractory metal oxide support. These oxides may include various oxidation states of the metal, such as monoxide, dioxide, trioxide, tetroxide, and the like, depending on the valence of the particular metal.

Suitable base metals include, but are not limited to, cerium, iron, cobalt, zinc, chromium, nickel, tungsten, copper, molybdenum, or combinations thereof. In some embodiments, the base metal is chosen from (e.g., selected from the group consisting of) cerium, copper, iron, cobalt, zinc, chromium, nickel, tungsten, molybdenum, and combinations thereof. In some embodiments, the base metal is chosen from (e.g., selected from the group consisting of) cerium, iron, cobalt, zinc, chromium, nickel, tungsten, molybdenum, and combinations thereof. In some embodiments, the base metal is chosen from (e.g., selected from the group consisting of) cerium, copper, and a combination thereof. In some embodiments, the base metal is chosen from cerium, iron, cobalt, zinc, chromium, molybdenum, nickel, tungsten, magnesium, antimony, tin, lead, yttrium, manganese, and combinations thereof.

In some embodiments, the oxidation catalyst composition is substantially free of copper. By “substantially free” of copper is meant that no copper has been intentionally added, and only trace amounts may be present as impurities, for example, less than 0.1%, less than 0.01%, less than 0.001%, or even 0% by weight.

The concentration of any individual first oxide can vary, but will typically be from about 1 wt % to about 50 wt % relative to the weight of the refractory metal oxide support material on which it is supported (e.g., about 1% to about 50%, about 1% to about 30%, or about 5% to about 20% by weight, relative to the weight of the refractory metal oxide support). In some embodiments, the concentration of any individual first oxide is from about 1%, about 2%, about 3%, about 4%, about 5%, about 6%, about 7%, about 8%, about 9%, or about 10%, to about 15%, about 20%, about 25%, about 30%, about 35%, about 40%, about 45%, or about 50% by weight, based on the weight of the refractory oxide support material.

In some embodiments, the first oxide is supported on the first refractory metal oxide support material. In some embodiments, the first oxide is ceria. In some embodiments, the ceria is present in an amount up to about 50% by weight, based on the weight of the first refractory metal oxide support material. In some embodiments, the ceria is present in an amount from about 1% to about 10%, from about 5% to about 20%, from about 10% to about 30%, or from about 20 to about 50% by weight, based on the weight of the first refractory metal oxide support material.

### Preparation of the Oxidation Catalyst Composition

The disclosed oxidation catalyst composition may, in some embodiments, be prepared via an incipient wetness impregnation method. Incipient wetness impregnation techniques, also called capillary impregnation, or dry impregnation are commonly used for the synthesis of heterogeneous materials, i.e., catalysts. Typically, a metal precursor (e.g., a PGM or base metal/metalloid oxide precursor) is dissolved in an aqueous or organic solution and then the metal-containing solution is added to a refractory metal oxide support containing the same pore volume as the volume of the solution that was added. Capillary action draws the solution into the pores of the support. Solution added in excess of the support pore volume causes the solution transport to change from a capillary action process to a diffusion process, which is much slower. The catalyst can then be dried and calcined to remove the volatile components within the solution, depositing the metal on the surface of the catalyst support. The maximum loading is limited by the solubility of the precursor in the solution. The concentration profile of the impregnated material depends on the mass transfer conditions within the pores during impregnation and drying. One of skill in the art will recognize other methods for loading the various components (e.g., a PGM or base metal/metalloid) into the supports of the present compositions, for example, adsorption, precipitation, and the like.

During the subsequent calcination steps, or at least during the initial phase of use of the composition, the metal precursor compounds are converted into a catalytically active form of the metal or a compound thereof. Non-limiting examples of suitable PGM precursors include palladium nitrate, tetraamine palladium nitrate, tetraamine platinum acetate, and platinum nitrate. Non-limiting examples of suitable base metal oxide precursors are nitrates, acetates, or other soluble salts of, e.g., cerium, copper, and the like. A suitable method of preparing an oxidation catalyst composition is to prepare a mixture of a solution of a desired PGM compound (e.g., a platinum compound and/or a palladium compound) and at least one support, such as a finely divided, high surface area, refractory metal oxide support. e.g., lanthana-doped zirconia, which is sufficiently dry to absorb substantially all of the solution to form a wet solid which is later combined with water to form a coatable slurry. In some embodiments, the slurry is acidic, having, for example, a pH of about 2 to less than about 7. The pH of the slurry may be lowered by the addition of an adequate amount of an inorganic acid or an organic acid to the slurry. Combinations of both can be used when compatibility of acid and raw materials is considered. Example inorganic acids include, but are not limited to, nitric acid. Example organic acids include, but are not limited to, acetic, propionic, oxalic, malonic, succinic, glutamic, adipic, maleic, fumaric, phthalic, tartaric, citric acid and the like. The impregnated refractory metal oxide support material is then dried and calcined as described above.

The wet impregnation method described above can similarly be used to introduce the first oxide component into the refractory metal oxide support material. The impregnations can be conducted in a step-wise (sequential) fashion or in various combinations.

### Catalytic Articles

In one aspect is provided an oxidation catalyst article comprising the oxidation catalyst composition as disclosed herein. The article comprises a substrate having disposed on at least a portion thereof the oxidation catalyst composition as disclosed herein. Suitable substrates are described herein below.

### Substrates

In some embodiments, the present oxidation catalyst composition is disposed on a substrate to form a catalytic article. Catalytic articles comprising the substrates are generally employed as part of an exhaust gas treatment system (e.g., catalyst articles including, but not limited to, articles including the oxidation catalyst composition disclosed herein). Useful substrates are 3-dimensional, having a length and a diameter and a volume, similar to a cylinder. The shape does not necessarily have to conform to a cylinder. The length is an axial length defined by an inlet end and an outlet end.

In some embodiments, the substrate for the disclosed composition(s) may be constructed of any material typically used for preparing automotive catalysts and will typically comprise a metal or ceramic honeycomb structure. The substrate typically provides a plurality of wall surfaces upon which the washcoat composition is applied and adhered, thereby acting as a substrate for the catalyst composition.

Ceramic substrates may be made of any suitable refractory material, e.g., cordierite, cordierite-α-alumina, aluminum titanate, silicon titanate, silicon carbide, silicon nitride, zircon mullite, spodumene, alumina-silica-magnesia, zircon silicate, sillimanite, a magnesium silicate, zircon, petalite, α-alumina, an aluminosilicate and the like.

Substrates may also be metallic, comprising one or more metals or metal alloys. A metallic substrate may include any metallic substrate, such as those with openings or “punch-outs” in the channel walls. The metallic substrates may be employed in various shapes such as, e.g., pellets, corrugated sheet, or monolithic foam. Specific examples of metallic substrates include, but are not limited to, heat-resistant, base-metal alloys, especially those in which iron is a substantial or major component. Such alloys may contain one or more of nickel, chromium, and aluminum, and the total of these metals may advantageously comprise at least about 15 wt. % (weight percent) of the alloy, for instance, about 10% to about 25 wt. % chromium, about 1% to about 8 wt. % of aluminum, and from 0% to about 20 wt. % of nickel, in each case based on the weight of the substrate. Examples of metallic substrates include, but are not limited to, those having straight channels; those having protruding blades along the axial channels to disrupt gas flow and to open communication of gas flow between channels; and those having blades and also holes to enhance gas transport between channels allowing for radial gas transport throughout the monolith. Metallic substrates, in particular, may be advantageously employed in certain embodiments in a close-coupled position, allowing for fast heat-up of the substrate and, correspondingly, fast heat up of a catalyst composition coated therein (e.g., an oxidation catalyst composition).

Any suitable substrate for the catalytic articles disclosed herein may be employed, such as a monolithic substrate of the type having fine, parallel gas flow passages extending there through from an inlet or an outlet face of the substrate such that passages are open to fluid flow there through (“flow-through substrate”). Another suitable substrate is of the type having a plurality of fine, substantially parallel gas flow passages extending along the longitudinal axis of the substrate where, typically, each passage is blocked at one end of the substrate body, with alternate passages blocked at opposite end-faces (“wall-flow filter”). Flow-through and wall-flow substrates are also taught, for example, in International Application Publication No. WO2016/070090, which is incorporated herein by reference in its entirety.

In some embodiments, the catalyst substrate comprises a honeycomb substrate in the form of a wall-flow filter or a flow-through substrate. In some embodiments, the substrate is a wall-flow filter. Flow-through substrates and wall-flow filters will be further discussed herein below.

### Flow-Through Substrates

In some embodiments, the substrate is a flow-through substrate (e.g., monolithic substrate, including a flow-through honeycomb monolithic substrate). Flow-through substrates have fine, parallel gas flow passages extending from an inlet end to an outlet end of the substrate such that passages are open to fluid flow. The passages, which are essentially straight paths from their fluid inlet to their fluid outlet, are defined by walls on which a catalytic coating is disposed so that gases flowing through the passages contact the catalytic material. The flow passages of the flow-through substrate are thin-walled channels, which can be of any suitable cross-sectional shape and size such as trapezoidal, rectangular, square, sinusoidal, hexagonal, oval, circular, etc. The flow-through substrate can be ceramic or metallic as described above.

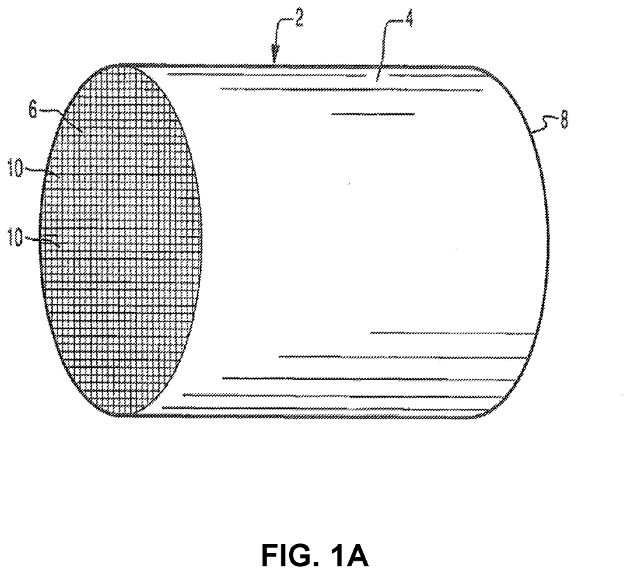

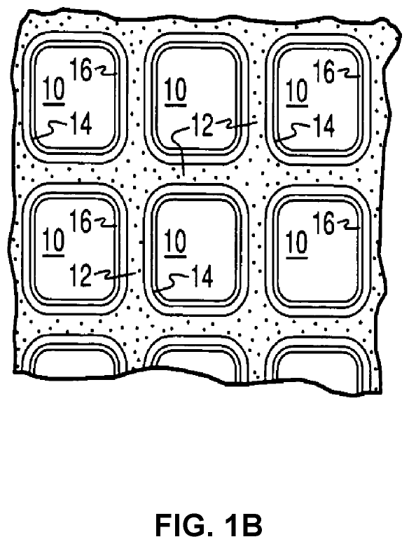

Flow-through substrates can, for example, have a volume of from about 50 in³ to about 1200 in³, a cell density (inlet openings) of from about 60 cells per square inch (cpsi) to about 500 cpsi or up to about 900 cpsi, for example, from about 200 to about 400 cpsi and a wall thickness of from about 50 to about 200 microns or about 400 microns. FIGS. 1A and 1B illustrate an exemplary substrate 2 in the form of a flow-through substrate coated with a catalyst composition as described herein. Referring to FIG. 1A, the exemplary substrate 2 has a cylindrical shape and a cylindrical outer surface 4, an upstream end face 6 and a corresponding downstream end face 8, which is identical to end face 6. Substrate 2 has a plurality of fine, parallel gas flow passages 10 formed therein. As seen in FIG. 1B, flow passages 10 are formed by walls 12 and extend through carrier 2 from upstream end face 6 to downstream end face 8, the passages 10 being unobstructed so as to permit the flow of a fluid, e.g., a gas stream, longitudinally through carrier 2 via gas flow passages 10 thereof. As more easily seen in FIG. 1B, walls 12 are so dimensioned and configured that gas flow passages 10 have a substantially regular polygonal shape. As shown, the catalyst composition can be applied in multiple, distinct layers if desired. In the illustrated embodiment, the catalyst composition consists of both a discrete bottom layer 14 adhered to the walls 12 of the carrier member and a second discrete top layer 16 coated over the bottom layer 14. The present disclosure can be practiced with one or more (e.g., two, three, or four or more) catalyst composition layers and is not limited to the two-layer embodiment illustrated in FIG. 1B. Further coating configurations are disclosed herein below.

### Wall-Flow Filter Substrates

In some embodiments, the substrate is a wall-flow filter, which generally has a plurality of fine, substantially parallel gas flow passages extending along the longitudinal axis of the substrate. Typically, each passage is blocked at one end of the substrate body, with alternate passages blocked at opposite end-faces. Such monolithic wall-flow filter substrates may contain up to about 900 or more flow passages (or “cells”) per square inch of cross-section, although far fewer may be used. For example, the substrate may have from about 7 to 600, more usually from about 100 to 400, cells per square inch (“cpsi”). The cells can have cross-sections that are rectangular, square, circular, oval, triangular, hexagonal, or are of other polygonal shapes.

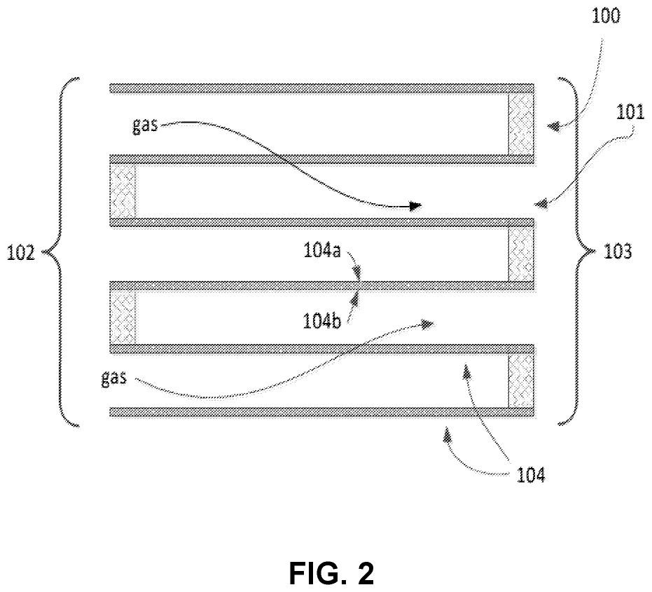

A cross-section view of a monolithic wall-flow filter substrate section is illustrated in FIG. 2, showing alternating plugged and open passages (cells). Blocked or plugged ends 100 alternate with open passages 101, with each opposing end open and blocked, respectively. The filter has an inlet end 102 and outlet end 103. The arrows crossing porous cell walls 104 represent exhaust gas flow entering the open cell ends, diffusion through the porous cell walls 104 and exiting the open outlet cell ends. Plugged ends 100 prevent gas flow and encourage diffusion through the cell walls. Each cell wall will have an inlet side 104a and outlet side 104b. The passages are enclosed by the cell walls.

The wall-flow filter article substrate may have a volume of, for instance, from about 50 cm³, about 100 cm³, about 200 cm³, about 300 cm³, about 400 cm³, about 500 cm³, about 600 cm³, about 7M) cm³, about 800 cm³, about 900 cm³ or about 1000 cm³ to about 1500 cm³, about 2000 cm³, about 2500 cm³, about 3000 cm³, about 3500 cm³, about 4000 cm³, about 4500 cm³ or about 5000 cm³. Wall-flow filter substrates typically have a wall thickness from about 50 microns to about 2000 microns, for example, from about 50 microns to about 450 microns or from about 150 microns to about 400 microns.

The walls of the wall-flow filter are porous and generally have a wall porosity of at least about 50% or at least about 60% with an average pore size of at least about 5 microns prior to disposition of the functional coating. For instance, the wall-flow filter article substrate in some embodiments will have a porosity of ≥50%, ≥60%, ≥65% or ≥70%. For instance, the wall-flow filter article substrate will have a wall porosity of from about 50%, about 60%, about 65% or about 70% to about 75%, about 80% or about 85% and an average pore size of from about 5 microns, about 10 microns, about 20 microns, about 30 microns, about 40 microns or about 50 microns to about 60 microns, about 70 microns, about 80 microns, about 90 microns or about 100 microns prior to disposition of a catalytic coating.

As used herein, the terms “wall porosity” and “substrate porosity” mean the same thing and are used interchangeably. Porosity is the ratio of void volume divided by the total volume of a substrate. Pore size may be determined according to ISO15901-2 (static volumetric) procedure for nitrogen pore size analysis. Nitrogen pore size may be determined on Micromeritics TRISTAR 3000 series instruments. Nitrogen pore size may be determined using BJH (Barrett-Joyner-Halenda) calculations and 33 desorption points. In some embodiments, useful wall-flow filters have high porosity, allowing high loadings of catalyst compositions without excessive backpressure during operation.

### Coating Compositions and Configurations

To produce catalytic articles of the present disclosure, a substrate as described herein is contacted with an oxidation catalyst composition as disclosed herein to provide a coating (i.e., a slurry comprising particles of the catalyst composition are disposed on a substrate). The coatings of the oxidation catalyst composition on the substrate are referred to herein, e.g., as “catalytic coating compositions” or “catalytic coatings.” As used herein, the terms “catalyst composition” and “catalytic coating composition” are synonymous.

Oxidation catalyst compositions as disclosed herein may be prepared using a binder, for example, a ZrO₂ binder derived from a suitable precursor such as zirconyl acetate or any other suitable zirconium precursor such as zirconyl nitrate. Zirconyl acetate binder provides a coating that remains homogeneous and intact after thermal aging, for example, when the catalyst is exposed to high temperatures of at least about 600° C., for example, about 800° C. and higher water vapor environments of about 5% or more. Other potentially suitable binders include, but are not limited to, alumina and silica. Alumina binders include aluminum oxides, aluminum hydroxides, and aluminum oxyhydroxides. Aluminum salts and colloidal forms of alumina many also be used. Silica binders include various forms of SiO₂, including silicates and colloidal silica. Binder compositions may include any combination of zirconia, alumina, and silica. Other exemplary binders include, but are not limited to, boehemite, gamma-alumina, or delta/theta alumina, as well as silica sol. When present, the binder is typically used in an amount of about 1-5 wt % of the total washcoat loading. Alternatively, the binder can be zirconia-based or silica-based, for example zirconium acetate, zirconia sol, or silica sol. When present, the alumina binder is typically used in an amount of about 0.05 g/in³ to about 1 g/in³. In some embodiments, the binder is alumina.

The present catalytic coating may comprise one or more coating layers, where at least one layer comprises the present (oxidation) catalyst composition. The present catalytic coating may comprise a single layer or multiple coating layers. The catalytic coating may comprise one or more thin, adherent coating layers disposed on and in adherence to least a portion of a substrate. The entire coating comprises the individual “coating layers”.

In some embodiments, the present catalytic articles may include the use of one or more catalyst layers and combinations of one or more catalyst layers. Catalytic materials may be present on the inlet side of the substrate wall alone, the outlet side alone, both the inlet and outlet sides, or the wall itself may consist all, or in part, of the catalytic material. The catalytic coating may be on the substrate wall surfaces and/or in the pores of the substrate walls, that is “in” and/or “on” the substrate walls. Thus, the phrase “a catalytic coating disposed on the substrate” means on any surface, for example, on a wall surface and/or on a pore surface.

The present catalyst compositions may typically be applied in the form of a washcoat, containing support material having catalytically active species thereon. A washcoat is formed by preparing a slurry containing a specified solids content (e.g., about 10% to about 60% by weight) of supports in a liquid vehicle, which is then applied to a substrate and dried and calcined to provide a coating layer. If multiple coating layers are applied, the substrate is dried and calcined after each layer is applied and/or after the number of desired multiple layers are applied. In one or more embodiments, the catalytic material(s) are applied to the substrate as a washcoat. Binders may also be employed as described above.

The above-noted catalyst composition(s) are generally independently mixed with water to form a slurry for purposes of coating a catalyst substrate, such as a honeycomb-type substrate. In addition to the catalyst particles, the slurry may optionally contain a binder (e.g., alumina, silica), water-soluble or water-dispersible stabilizers, promoters, associative thickeners, and/or surfactants (including anionic, cationic, non-ionic or amphoteric surfactants). A typical pH range for the slurry is about 3 to about 6. Addition of acidic or basic species to the slurry can be carried out to adjust the pH accordingly. For example, in some embodiments, the pH of the slurry is adjusted by the addition of ammonium hydroxide or aqueous nitric acid.

The slurry can be milled to enhance mixing of the particles and formation of a homogenous material. The milling can be accomplished in a ball mill, continuous mill, or other similar equipment, and the solids content of the slurry may be, e.g., about 20-60 wt %, more particularly about 20-40 wt %. In some embodiments, the post-milling slurry is characterized by a D₉₀ particle size of about 10 microns to about 40 microns, such as, e.g., 10 microns to about 30 microns, such as, e.g., about 10 microns to about 15 microns.

The slurry is then coated on the catalyst substrate using any washcoat technique known in the art. In some embodiments, the catalyst substrate is dipped one or more times in the slurry or otherwise coated with the slurry. Thereafter, the coated substrate is dried at an elevated temperature (e.g., 100-150° C.) for a period of time (e.g., 10 min-3 hours) and then calcined by heating, e.g., at 400-600° C., typically for about 10 minutes to about 3 hours. Following drying and calcining, the final washcoat coating layer can be viewed as essentially solvent-free.

After calcining, the catalyst loading obtained by the above described washcoat technique can be determined through calculation of the difference in coated and uncoated weights of the substrate. As will be apparent to those of skill in the art, the catalyst loading can be modified by altering the slurry rheology. In addition, the coating/drying/calcining process to generate a washcoat can be repeated as needed to build the coating to the desired loading level or thickness, meaning more than one washcoat may be applied.

In some embodiments, the catalytic article comprises a catalytic coating disposed on at least a portion of the substrate, the catalytic coating comprising a first washcoat and a second washcoat. In some embodiments, the first washcoat comprises a first oxide and a first refractory metal oxide support material, each as described herein. In some embodiments, the first oxide is supported on the first refractory metal oxide support material.

In some embodiments, the second washcoat comprises a platinum group metal (PGM) component comprising palladium and a second refractory metal oxide support material, each as described herein. In some embodiments, the PGM component is supported on the second refractory metal oxide support material.

The washcoats can be applied such that different coating layers may be in direct contact with the substrate. Alternatively, one or more “undercoats” may be present, so that at least a portion of a catalytic or sorbent coating layer or coating layers are not in direct contact with the substrate (but rather, are in contact with the undercoat). One or more “overcoats” may also be present, so that at least a portion of the coating layer or layers are not directly exposed to a gaseous stream or atmosphere (but rather, are in contact with the overcoat). The present catalyst composition may be in a bottom layer over a substrate.

Alternatively, the present catalyst composition may be in a top coating layer over a bottom coating layer. The catalyst composition may be present in a top and a bottom layer. Any one layer may extend the entire axial length of the substrate, for instance, a bottom layer may extend the entire axial length of the substrate and a top layer may also extend the entire axial length of the substrate over the bottom layer. Each of the top and bottom layers may extend from either the inlet or outlet end.

For example, both bottom and top coating layers may extend from the same substrate end where the top layer partially or completely overlays the bottom layer and where the bottom layer extends a partial or full length of the substrate and where the top layer extends a partial or full length of the substrate. Alternatively, a top layer may overlay a portion of a bottom layer. For example, a bottom layer may extend the entire length of the substrate and the top layer may extend about 10%, about 20%, about 30%, about 40%, about 50%, about 60%, about 70%, about 80%, or about 90% of the substrate length, from either the inlet or outlet end.

Alternatively, a bottom layer may extend about 10%, about 15%, about 25%, about 30%, about 40%, about 45%, about 50%, about 55%, about 60%, about 65%, about 70%, about 75%, about 80%, about 85%, or about 95% of the substrate length from either the inlet end or outlet end and a top layer may extend about 10%, about 15%, about 25%, about 30%, about 40%, about 45%, about 50%, about 55%, about 60%, about 65%, about 70%, about 75%, about 80%, about 85%, or about 95% of the substrate length from either the inlet end of outlet end, wherein at least a portion of the top layer overlays the bottom layer. This “overlay” zone may, for example, extend from about 5% to about 80% of the substrate length, for example, about 5%, about 10%, about 20%, about 30%, about 40%, about 50%, about 60%, or about 70% of the substrate length.

Top and/or bottom coating layers may be in direct contact with the substrate. Alternatively, one or more “undercoats” may be present, so that at least a portion of the top and/or the bottom coating layers are not in direct contact with the substrate (but rather with the undercoat). One or more “overcoats” may also be present, so that at least a portion of the top and/or bottom coating layers are not directly exposed to a gaseous stream or atmosphere (but rather are in contact with the overcoat). An undercoat is a layer “under” a coating layer, an overcoat is a layer “over” a coating layer, and an interlayer is a layer “between” two coating layers.

The top and bottom coating layers may be in direct contact with each other without any interlayer. Alternatively, different coating layers may not be in direct contact, with a “gap” between the two zones. An interlayer, if present, may prevent the top and bottom layers from being in direct contact. An interlayer may partially prevent the top and bottom layers from being in direct contact and thereby allow for partial direct contact between the top and bottom layers. The interlayer(s), undercoat(s), and overcoat(s) may contain one or more catalysts or may be free of catalysts. The present catalytic coatings may comprise more than one identical layers, for instance, more than one layer containing identical catalyst compositions.

The catalytic coating may advantageously be “zoned,” comprising zoned catalytic layers, that is, where the catalytic coating contains varying compositions across the axial length of the substrate. This may also be described as “laterally zoned”. For example, a layer may extend from the inlet end towards the outlet end, extending about 10%, about 20%, about 30%, about 40%, about 50%, about 60%, about 70%, about 80%, or about 90% of the substrate length. Another layer may extend from the outlet end towards the inlet end, extending about 10%, about 20%, about 30%, about 40%, about 50%, about 60%, about 70%, about 8(0%, or about 90% of the substrate length. Different coating layers may be adjacent to each other and not overlay each other. Alternatively, different layers may overlay a portion of each other, providing a third “middle” zone. The middle zone may, for example, extend from about 5% to about 80% of the substrate length, for example, about 5%, about 10%, about 20%, about 30%, about 40%, about 50%, about 60%, or about 70% of the substrate length.

Different layers may each extend the entire length of the substrate or may each extend a portion of the length of the substrate and may overlay or underlay each other, either partially or entirely. Each of the different layers may extend from either the inlet or outlet end. Different catalytic compositions may reside in each separate coating layer. The present catalytic coatings may comprise more than one identical layer.

Zones of the present disclosure are defined by the relationship of coating layers. With respect to different coating layers, there are a number of possible zoning configurations. For example, there may be an upstream zone and a downstream zone, there may be an upstream zone, a middle zone and a downstream zone, there may four different zones, etc. Where two layers are adjacent and do not overlap, there are upstream and downstream zones. Where two layers overlap to a certain degree, there are upstream, downstream and middle zones. Where for example, a coating layer extends the entire length of the substrate and a different coating layer extends from the outlet end a certain length and overlays a portion of the first coating layer, there are upstream and downstream zones.

In some embodiments, first and second coating layers may be overlaid, either first over second or second over first (i.e., top/bottom), for example, where the first coating layer extends from the inlet end towards the outlet end and where the second coating layer extends from the outlet end towards the inlet end. In this case, the catalytic coating will comprise an upstream zone, a middle (overlay) zone and a downstream zone. The first and/or second coating layers may be synonymous with the above top and/or bottom layers described above.

In some embodiments, a first coating layer may extend from the inlet end towards the outlet end and a second coating layer may extend from the outlet end towards the inlet end, where the layers do not overlay each other, for example they may be adjacent.

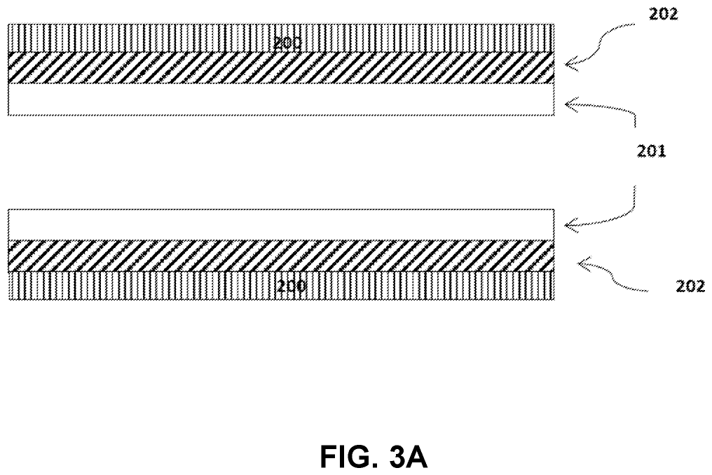

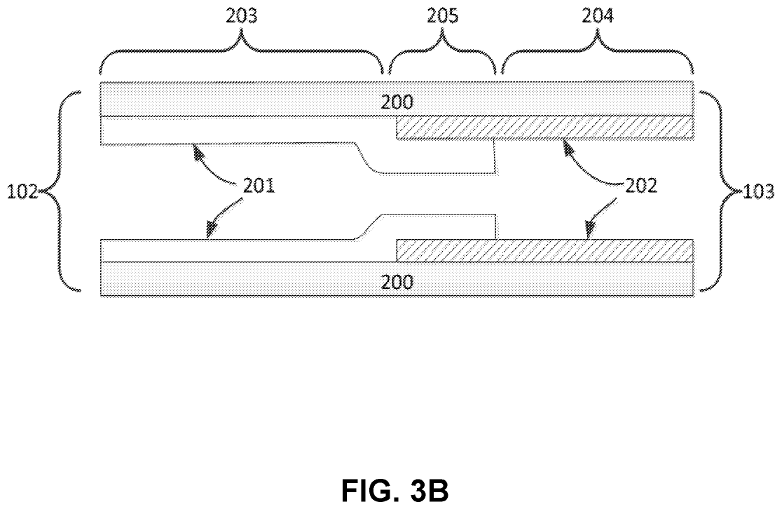

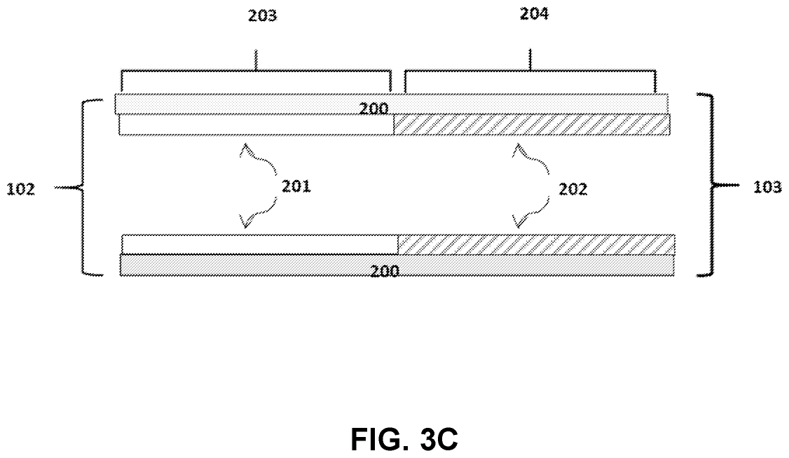

FIGS. 3A, 3B, and 3C show some possible coating layer configurations with two coating layers, wherein at least one of said coating layers comprises the catalyst composition as disclosed herein. Shown are substrate walls 200 onto which coating layers 201 (top coat) and 202 (bottom coat) are disposed. These are simplified illustrations, and in the case of a porous wall-flow substrate, not shown are pores and coatings in adherence to pore walls and not shown are plugged ends. In FIG. 3A, coating layers 201 and 202 each extend the entire length of the substrate with top layer 201 overlaying bottom layer 202. The substrate of FIG. 3A does not contain a zoned coating configuration. In FIG. 3B, bottom coating layer 202 extends from the outlet about 50% of the substrate length and top coating layer 201 extends from the inlet greater than 50% of the length and overlays a portion of layer 202, providing an upstream zone 203, a middle overlay zone 205 and a downstream zone 204. In FIG. 3C, coating layer 202 extends from the outlet about 50% of the substrate length and coating layer 201 extends from the inlet greater than 50% of the length and overlays a portion of layer 202, providing an upstream zone 203, a middle overlay zone 205, and a downstream zone 204. FIGS. 3A, 3B, and 3C may be useful to illustrate coating compositions on a wall-through substrate or the flow-through substrate.

In some embodiments, the first and second washcoats are substantially free of copper.

In some embodiments, the first washcoat is disposed directly on the substrate, and the second washcoat is on at least a portion of the first washcoat. In some embodiments, the second washcoat is disposed directly on the substrate, and the first washcoat is on at least a portion of the second washcoat.

In some embodiments, the catalytic article has a zoned configuration, wherein the first washcoat is disposed directly on the substrate from the outlet end to a length from about 20% to about 100% of the overall length; and the second washcoat is disposed on the substrate from the inlet end to a length from about 20% to about 100% of the overall length. In some embodiments, the catalytic article has a zoned configuration, wherein the second washcoat is disposed directly on the substrate from the outlet end to a length from about 20% to about 100% of the overall length; and the first washcoat is disposed on the substrate from the inlet end to a length from about 20% to about 100% of the overall length.

The present (oxidation) catalytic coating, as well as any zone or any layer or any section of a coating, is present on the substrate at a loading (concentration) of, for instance, from about 0.3 g/in³ to about 6.0 g/in³, or from about 0.4, about 0.5, about 0.6, about 0.7, about 0.8, about 0.9 or about 1.0 g/in³ to about 1.5 g/in³, about 2.0 g/in³, about 2.5 g/in³, about 3.0 g/in³, about 3.5 g/in³, about 4.0 g/in³, about 4.5 g/in³, about 5.0 g/in³ or about 5.5 g/in³, based on the volume of the substrate. This refers to dry solids weight per volume of substrate, for example per volume of a honeycomb monolith. Concentration is based on a cross-section of a substrate or on an entire substrate. In some embodiments, a top coating layer is present at a lower loading than the bottom coating layer.

The loading of the PGM component (e.g., palladium, and optionally platinum) of the disclosed oxidation catalyst composition on the substrate may be in the range of about 2 g/ft³, about 5 g/ft³, or about 10 g/ft³ to about 250 g/ft³, for example from about 20 g/ft³, about 30 g/ft³, about 40 g/ft³, about 50 g/ft³ or about 60 g/ft³ to about 100 g/ft³, about 150 g/ft³ or about 200 g/ft³, about 210 g/ft³, about 220 g/ft³, about 230 g/ft³, about 240 g/ft³ or about 250 g/ft³, based on the volume of the substrate. The PGM is, for example, present in a catalytic layer from about 0.1 wt %, about 0.5 wt %, about 1.0 wt %, about 1.5 wt % or about 2.0 wt % to about 3 wt %, about 5 wt %, about 7 wt %, about 9 wt %, about 10 wt %, about 12 wt % or about 15 wt %, based on the weight of the layer.

### Catalyst Activity

In some embodiments, the level of hydrocarbons, e.g., methane, or CO present in the exhaust gas stream is reduced compared to the level of hydrocarbons or CO present in the exhaust gas stream prior to contact with the catalyst article. In some embodiments, the efficiency for reduction of HC and/or CO level is measured in terms of the conversion efficiency. In some embodiments, conversion efficiency is measured as a function of light-off temperature (i.e., T₅₀ or T₅₀). The T₅₀ or T₅₀ light-off temperature is the temperature at which the catalyst composition is able to convert 50% or 70%, respectively, of hydrocarbons or carbon monoxide to carbon dioxide and water. Typically, the lower the measured light-off temperature for any given catalyst composition, the more efficient the catalyst composition is to carry out the catalytic reaction, e.g., hydrocarbon conversion.

In some embodiments, sulfur poisoning is not observed.

In some embodiments, the level of nitrogen dioxide (NO₂) in the exhaust gas stream is increased compared to the level of NO₂ present in the exhaust gas stream prior to contact with the catalyst article. Such an increase in NO₂ content is generally beneficial in promoting the catalytic activity of a downstream SCR catalyst.

### Exhaust Gas Treatment Systems

In another aspect is provided a system for treatment of an exhaust gas stream from an internal combustion engine containing hydrocarbons (HCs), carbon monoxide (CO), and nitrogen oxides (NO). The system comprises a diesel oxidation catalyst (DOC) article as described herein located downstream of the internal combustion engine. The engine can be, e.g., a diesel engine which operates at combustion conditions with air in excess of that required for stoichiometric combustion, i.e., lean conditions. In other embodiments, the engine can be a gasoline engine (e.g., a lean burn gasoline engine) or an engine associated with a stationary source (e.g., electricity generators or pumping stations)

Exhaust gas treatment systems generally contain more than one catalytic article positioned downstream from the engine in fluid communication with the exhaust gas stream. A system may contain, for instance, oxidation catalyst article as disclosed herein (e.g., a DOC), a selective catalytic reduction catalyst (SCR), and one or more articles including a reductant injector, a soot filter, an ammonia oxidation catalyst (AMOx), or a lean NOₓ trap (LNT). An article containing a reductant injector is a reduction article. A reduction system includes a reductant injector and/or a pump and/or a reservoir, etc. The present treatment system may further comprise a soot filter and/or an ammonia oxidation catalyst. A soot filter may be uncatalyzed or may be catalyzed (CSF), such as a CSF as disclosed herein. For instance, the present treatment system may comprise, from upstream to downstream—an article containing a DOC, a CSF, a urea injector, a SCR article and an article containing an AMOx. A lean NOₓ trap (LNT) may also be included.

The relative placement of the various catalytic components present within the emission treatment system can vary. In the present exhaust gas treatment systems and methods, the exhaust gas stream is received into the article(s) or treatment system by entering the upstream end and exiting the downstream end. The inlet end of a substrate or article is synonymous with the “upstream” end or “front” end. The outlet end is synonymous with the “downstream” end or “rear” end. The treatment system is, in general, downstream of and in fluid communication with an internal combustion engine.

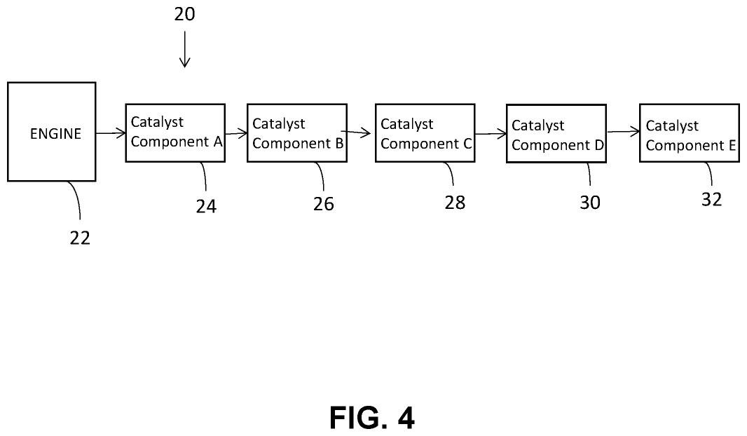

One exemplary emission treatment system is illustrated in FIG. 4, which depicts a schematic representation of an emission treatment system 20. As shown, the emission treatment system can include a plurality of catalyst components in series downstream of an engine 22, such as a lean burn engine. At least one of the catalyst components will comprise the oxidation catalyst composition of the disclosure as set forth herein (e.g., a DOC, a CSF, or both). The oxidation catalyst composition of the disclosure could be combined with numerous additional catalyst materials and could be placed at various positions in comparison to the additional catalyst materials. FIG. 4 illustrates five catalyst components, 24, 26, 28, 30, 32 in series; however, the total number of catalyst components can vary and five components is merely one example.

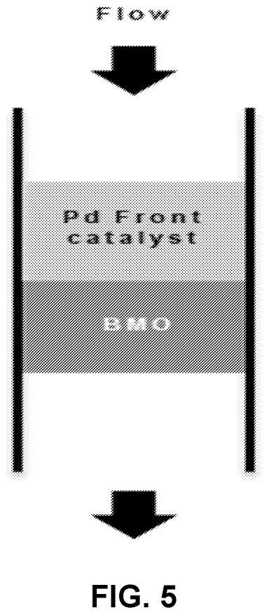

Without limitation, Table 1 presents various exhaust gas treatment system configurations of one or more embodiments of this disclosure. It is noted that each catalyst is connected to the next catalyst via exhaust conduits such that the engine is upstream of catalyst A, which is upstream of catalyst B, which is upstream of catalyst C, which is upstream of catalyst D, which is upstream of catalyst E (when present). The reference to Components A-E in the table can be cross-referenced with the same designations in FIG. 5.

The DOC catalyst noted in Table 1 can be any catalyst conventionally used as a diesel oxidation catalyst to effectively convert CO and HC to CO₂ and H₂O.

The ccDOC catalyst noted in Table 1 can be any catalyst conventionally used as a diesel oxidation catalyst, located in a close-coupled position toward the engine block, to convert CO and HC to CO₂ and H₂O, and which generates heat through the reaction exotherm to effectively heat downstream catalysts.

The DOC(BMO) catalyst noted in Table 1 can be any catalyst conventionally used as a diesel oxidation catalyst to convert CO and HC to CO₂ and H₂O, and which does not include a platinum group metal (PGM). The BMO is denoted as base metal oxides as defined herein. The combination of Component A (DOC)+Component B (DOC(BMO)) is expressed as an arrangement of Component A located upstream of Component B, either in the same canister or in two separate canisters.

The DOC+BMO catalyst noted in Table 1 is a diesel oxidation catalyst comprising both PGM and BMO components on the same substrate.

The LNT catalyst noted in Table 1 can be any catalyst conventionally used as a NOₓ trap, and typically comprises NOₓ-adsorber compositions that include base metal oxides (BaO, MgO, CeO₂, and the like) and a platinum group metal for catalytic NO oxidation and reduction (e.g., Pt and Rh).

The LT-NA catalyst noted in Table 1 can be any catalyst that can adsorb NOₓ (e.g., NO or NO₂) at low temperatures (<250° C.) and release it to the gas stream at high temperatures (>250° C.). The released NOₓ is generally converted to N₂ and H₂O over a downstream SCR or SCRoF catalyst. Typically, a LT-NA catalyst comprises Pd-promoted zeolites or Pd-promoted refractory metal oxides.

Reference to SCR in the table refers to an SCR catalyst. Reference to SCRoF (or SCR on filter) refers to a particulate or soot filter (e.g., a wall-flow filter), which can include an SCR catalyst composition.

Reference to AMOx in the table refers to an ammonia oxidation catalyst, which can be provided downstream of the catalyst of one more embodiments of the disclosure to remove any slipped ammonia from the exhaust gas treatment system. In some embodiments, the AMOx catalyst may comprise a PGM component. In some embodiments, the AMOx catalyst may comprise a bottom coat with PGM and a top coat with SCR functionality.

As will be recognized by one skilled in the art, in the configurations listed in Table 1, any one or more of components A, B, C, D, or E can be disposed on a particulate filter, such as a wall flow filter, or on a flow-through honeycomb substrate. In some embodiments, an engine exhaust system comprises one or more catalyst compositions mounted in a position near the engine (in a close-coupled position, CC), with additional catalyst compositions in a position underneath the vehicle body (in an underfloor position, UF). In some embodiments, the exhaust gas treatment system may further comprise a urea injection component.

TABLE 1
Possible exhaust gas treatment system configurations

| Component | Component | Component | Component | Component |
|---|---|---|---|---|
| A | B | C | D | E |
| ccDOC | DOC | SCR (or | Optional | — |
| | | SCROF) | AMOx | |
| DOC | DOC (BMO) | SCR (or | Optional | — |
| | | SCROF) | AMOx | |
| DOC + BMO | SCR (or | Optional | — | — |
| | SCRoF) | AMOx | | |
| DOC (BMO) | SCR (or | Optional | | |
| | SCRoF) | AMOx | | |
| DOC | LT-NA | CSF | SCR | Optional |
| | | | | AMOx - |
| LT-NA | DOC | CSF | SCR | Optional |
| | | | | AMOx |
| DOC | LT-NA/DOC | SCR (or | Optional | Optional |
| | | SCROF) | CSF | AMOx |
| LT-NA/DOC | DOC | SCR (or | Optional | Optional |
| | | SCROF) | CSF | AMOx |

### Method of Treating an Exhaust Gas Stream

Aspects of the current disclosure are directed towards a method for treating an engine exhaust gas stream comprising hydrocarbons and/or carbon monoxide, and/or NOₓ, the method comprising contacting the exhaust gas stream with the catalytic article of the present disclosure, or the emission treatment system of the present disclosure.

In general, hydrocarbons (HCs) and carbon monoxide (CO) present in the exhaust gas stream of any engine can be converted to carbon dioxide and water. Typically, hydrocarbons present in engine exhaust gas stream comprise C₁-C₆ hydrocarbons (i.e., lower hydrocarbons), such as methane, although higher hydrocarbons (greater than C₆) can also be detected. In some embodiments, the method comprises contacting the gas stream with the catalytic article or the exhaust gas treatment system of the present disclosure, for a time and at a temperature sufficient to reduce the levels of CO and/or HC in the gas stream.

In general, NOₓ species such as NO present in the exhaust gas stream of any engine can be converted (oxidized) to NO₂. In some embodiments, the method comprises contacting the gas stream with the catalytic article or the exhaust gas treatment system of the present disclosure, for a time and at a temperature sufficient to oxidize at least a portion of the NO present in the gas stream to NO₂.

The present articles, systems, and methods are suitable for treatment of exhaust gas streams from mobile emissions sources such as trucks and automobiles. The present articles, systems and methods are also suitable for treatment of exhaust streams from stationary sources such as power plants.

It will be readily apparent to one of ordinary skill in the relevant arts that suitable modifications and adaptations to the compositions, methods, and applications described herein can be made without departing from the scope of any embodiments or aspects thereof. The compositions and methods provided are exemplary and are not intended to limit the scope of the claimed embodiments. All of the various embodiments, aspects, and options disclosed herein can be combined in all variations. The scope of the compositions, formulations, methods, and processes described herein include all actual or potential combinations of embodiments, aspects, options, examples, and preferences herein. All patents and publications cited herein are incorporated by reference herein for the specific teachings thereof as noted, unless other specific statements of incorporation are specifically provided.

### EXAMPLES

This disclosure is more fully illustrated by the following examples, which are set forth to illustrate the present subject matter and is not to be construed as limiting thereof. Unless otherwise noted, all parts and percentages are by weight, and all weight percentages are expressed on a dry basis, meaning excluding water content, unless otherwise indicated.

### Example 1A: Pd on Lanthanum-Containing Zirconia Support

A sample of 2% palladium on a lanthanum-containing zirconia was prepared. A measured amount of Pd nitrate solution was impregnated onto a La-containing zirconia support (containing about 9% lanthanum oxide by weight), resulting in a coated powder with 2% by weight of Pd, based on the total weight of the impregnated support. The Pd impregnated support powder was added to deionized water (solid content of the slurry was 30 wt. %). The slurry was milled to a particle size with D₉₀ less than 15 μm using a ball mill. The milled slurry was dried at 120° C. under stirring and calcined at 590° C. for 2 hours in air. The calcined sample was cooled in air until reaching room temperature. The calcined powder was crushed and sieved to a particle size in the range of 250-500 μm. The sieved powder was divided into two portions. The first portion was evaluated as the fresh sample. The second portion was aged in air with 10% steam for 16 hours at 800° C., to provide an aged sample.

### Example 1B: Pt and Pd on Alumina Support

A sample of platinum and palladium (2% total PGM by weight) on an alumina support was prepared. Platinum nitrate and palladium nitrate (Pt and Pd in a ratio by weight of 2:1) were by impregnated on high surface area alumina (surface area of about 150 m²/g) according to standard procedures. The 2% PGM impregnated alumina support powder was added to deionized water (solid content of the slurry was 30 wt. %). The slurry was milled to a particle size with Do less than 15 μm using a ball mill. The milled slurry was dried at 120° C. under stirring and calcined at 590° C. for 2 hours in air. The calcined sample was cooled in air until reaching room temperature. The calcined powder was crushed and sieved to a particle size in the range of 250-500 μm. The sieved powder was divided into two portions. The first portion was evaluated as the fresh sample. The second portion was aged in air with 10% steam for 16 hours at 800° C., to provide an aged sample.

### Example 2: Ce/Mn Doped Alumina Support

A base metal oxide material was prepared by impregnation of cerium nitrate onto an alumina support, followed by drying. The cerium-impregnated alumina support was then impregnated with manganese nitrate, dried, calcined, crushed, and sieved as in Examples 1A and 1B to provide a Ce/Mn doped alumina support material (particle size in the range of 250-500 μm) containing 10% ceria and 10% manganese oxide by weight on alumina, based on the total weight of the doped alumina support material. The sieved powder was divided into two portions. The first portion was evaluated as the fresh sample. The second portion was aged in air with 10% steam for 16 hours at 800° C., to provide an aged sample.

### Example 3: Mn Doped Lanthanum-Containing Zirconia Support

A base metal oxide material was prepared by impregnation of manganese nitrate onto a La-containing zirconia support (containing about 9% lanthanum oxide by weight) using the procedure of Example 2, but replacing alumina with La-zirconia and eliminating the cerium nitrate. After calcination, the resulting powder had about 10% Mn content by weight, calculated as the oxides and based on the total weight of the impregnated support.

### Example 4: Ce/Mn Doped Lanthanum-Containing Zirconia Support

A base metal oxide material was prepared by sequential impregnation of cerium nitrate and manganese nitrate onto a La-containing zirconia support (containing about 9% lanthanum oxide by weight) using the procedure of Example 3. After calcination, the resulting powder had about 10% Ce and 10% Mn content by weight, calculated as the oxides and based on the total weight of the impregnated support.

### Example 5: Cu/Mn Doped Lanthanum-Containing Zirconia Support

A base metal oxide material was prepared by sequential impregnation of copper nitrate and manganese nitrate onto a La-containing zirconia support (containing about 9% lanthanum oxide by weight) using the procedure of Example 4, but substituting copper nitrate for the cerium nitrate. After calcination, the resulting powder had about 10% Cu and 10% Mn content by weight, calculated as the oxides and based on the total weight of the impregnated support.

### Example 6: Ce/Cu/Mn Doped Lanthanum-Containing Zirconia Support

A base metal oxide material was prepared by sequential impregnation of cerium nitrate, copper nitrate and manganese nitrate onto a La-containing zirconia support (containing about 9% lanthanum oxide by weight) using the procedure of Example 5, but impregnating first with cerium nitrate. After calcination, the resulting powder had about 10% Ce, 10% Cu and 10% Mn content by weight, calculated as the oxides and based on the total weight of the impregnated support.

### Examples 7-12. Pd Catalyst Articles

Catalyst articles were prepared from the powders of Examples 1A and 2-6. To prepare the articles, the appropriate powder samples (fresh and aged) were loaded into individual testing beds. The testing beds had a total volume of 1 milliliter, and two equal sections: a bottom and top, as shown in FIG. 5. In each case, the top portion was filled with the 2% Pd on La/Zr support powder of Example 1A, and the bottom portion of the testing bed was filled with a reference lanthanum-containing zirconia support (Example 7), or with the support of one of Examples 2-6 (Examples 8-12), mixed with an equal quantity of corundum. The composition of the articles is summarized in Table 2.

### Example 13. Reference Pt/Pd Catalyst Article

A catalyst article was prepared from the powder of Example 1B. To prepare the article, the appropriate powder samples (fresh) were loaded into a testing bed. The testing bed had a total volume of 1 milliliter, and two equal sections: a bottom and top, as shown in FIG. 5. The top layer was filled with the 2% Pt/Pd (2:1 Pt/Pd) on alumina of Example 1B, and the bottom portion of the testing bed was filled with a reference lanthanum-containing zirconia support without additional dopants. The composition of the articles is summarized in Table 2.

### Example 14. Pt/Pd Catalyst Article

A catalyst article was prepared from the powder of Example 1B. To prepare the article, the appropriate powder samples (fresh) were loaded into a testing bed. The testing bed had a total volume of 1 milliliter, and two equal sections: a bottom and top, as shown in FIG. 5. The top layer was filled with the 2% Pt/Pd (2:1 Pt/Pd) on alumina of Example 1B, and the bottom portion of the testing bed was filled with the Ce/Mn/La/ZrO₂ support of Example 4. The composition of the articles is summarized in Table 2.

TABLE 2
Layer compositions of articles of Examples 7-14

| Example # | Top layer | Bottom Layer |
|---|---|---|
| 7 | 2% Pd on La/ZrO₂ | La/ZrO₂, blended with corundum |
| (Reference) | (Example 1A) | |
| 8 | 2% Pd on La/ZrO₂ | Ce/Mn/Al₂O₃ (Example 2) |
| | (Example 1A) | blended with corundum |
| 9 | 2% Pd on La/ZrO₂ | Mn/La/ZrO₂ (Example 3) |
| | (Example 1A) | blended with corundum |
| 10 | 2% Pd on La/ZrO₂ | Ce/Mn/La/ZrO₂ (Example 4) |
| | (Example 1A) | blended with corundum |
| 11 | 2% Pd on La/ZrO₂ | Cu/Mn/La/ZrO₂ (Example 5) |
| | (Example 1A) | blended with corundum |
| 12 | 2% Pd on La/ZrO₂ | Ce/Cu/Mn/La/ZrO₂ (Example 6) |
| | (Example 1A) | blended with corundum |
| 13 | 2% 2:1 Pt/Pd on | La/ZrO₂, blended with corundum |
| (Reference) | La/ZrO₂ (Example 1B) | |
| 14 | 2% 2:1 Pt/Pd on | Ce/Mn/La/ZrO₂ (Example 4) |
| | La/ZrO₂ (Example 1B) | blended with corundum |

### Example 15: Reactor Testing Light-Off Experiments

The articles of Examples 7-12 (both fresh and aged) and 13 and 14 (fresh) were evaluated for hydrocarbon (HC) and carbon monoxide (CO) light-off in a reactor under steady-state conditions. The gas feed was CO at 1250 ppm, ethylene at 100 ppm (CI basis), 2:1 decane-toluene mix at 300 ppm (CI basis), nitric oxide at 180 ppm, carbon dioxide at 10%, water vapor at 10%, and oxygen (O₂) at 10%. For steady-state light-off, a stepwise 3-minute equilibration time was used, plus a 30 second sampling time for temperatures from 135-400° C. The first light-off test was treated as a de-greening of the sample, and the second light-off test was then recorded.

As a measure of the performance of fresh and aged catalysts the CO (T₅₀_CO) and HC (T₇₀_HC) light-off temperatures and NO₂ yields were determined. The CO (T₅₀_CO) and HC (T₇₀_HC) light-off temperatures are provided in Table 3, which demonstrated that all inventive articles show improved HC conversion, for fresh or aged samples.

While the Ce—Mn impregnated on alumina support (Example 8) provided improved HC performance over Example 7 (Reference article), the use of a lanthanum-containing zirconia support (Examples 9-12) instead of an alumina support further enhanced HC performance, fresh or aged. Without wishing to be bound by theory, this is indicative of a Mn—Zr synergism which was beneficial for enhancing HC performance. Surprisingly, the presence of both cerium and copper (Example 12) increased the HC light off temperature relative to samples with Cu and Mn, Mn alone, or Ce and Mn (Examples 11, 9, and 10, respectively).

While the reference catalyst article containing Pt/Pd impregnated alumina support (Example 13) provided improved HC/CO performance over Example 7 (Reference article), the addition of ceria and manganese on a lanthanum-containing zirconia support (Examples 14) further surprisingly enhanced HC performance (Table 3).

TABLE 3
HC/CO Light-Off (L/O) Temperatures

| State | Example # | HC₇₀ L/O, ° C. | CO₅₀ L/O, ° C. |
|---|---|---|---|
| Fresh | Example 7 (Ref) | 306 | 211 |
| | Example 8 | 272 | 209 |
| | Example 9 | 255 | 207 |
| | Example 10 | 252 | 209 |
| | Example 11 | 255 | 195 |
| | Example 12 | 271 | 193 |
| | Example 13 | 213 | 168 |
| | Example 14 | 203 | 167 |
| Aged | Example 7 (Ref) | 332 | 225 |
| | Example 8 | 292 | 224 |
| | Example 9 | 284 | 225 |
| | Example 10 | 285 | 231 |
| | Example 11 | 286 | 217 |
| | Example 12 | 289 | 217 |

As a further performance measurement criterion the NO₂ yields were evaluated at an inlet temperature of 300° C. The data are provided in Table 4, which demonstrated that all inventive articles, either fresh or aged, offered significantly higher NO₂ yield than the reference article (Example 7). The noted Mn—Zr synergism for HC light off was also beneficial for improving NO₂ yield. This enhanced NO₂ yield is expected to yield benefits to a downstream SCR catalyst, as shown in Table 4. In addition, this synergism enhanced NO₂ performance stability against aging, while Ce—Mn on alumina did not. Further, the addition of Cu onto the Mn/La—Zr support (Examples 11 and 12) resulted in an enhanced CO conversion, fresh or aged. Surprisingly, however, the addition of Cu compromised HC conversion and NO₂ yield compared with Examples 9 and 10.

TABLE 4
NO₂ yield at 300° C.

| State | Example # | NO₂ yield, % |
|---|---|---|
| Fresh | Example 7 (Ref) | 4 |
| | Example 8 | 29 |
| | Example 9 | 72 |
| | Example 10 | 87 |
| | Example 11 | 49 |
| | Example 12 | 36 |
| Aged | Example 7 (Ref) | 4 |
| | Example 8 | 4 |
| | Example 9 | 53 |
| | Example 10 | 50 |
| | Example 11 | 35 |
| | Example 12 | 25 |

As a further performance measurement criterion for Examples 13 and 14, the NO₂ yields were evaluated at an inlet temperature of 225° C. The data are provided in Table 5, which demonstrated that the inventive article of Example 14, even with Pt/Pd on alumina support as the top laver, offered significantly higher NO₂ yield than the reference article (Example 13).

TABLE 5
NO₂ yield at 225° C.

| State | Example # | NO₂ yield, %@225° C. |
|---|---|---|
| Fresh | Example 13 (Ref) | 28 |
| | Example 14 | 51 |

### Example 16: Reactor Testing Light-Off Experiments with Formaldehyde

Formaldehyde emissions from automotive exhaust gas are now regulated in the United States. Accordingly, the performance of the articles of Examples 7-12 was evaluated according to the protocol of Example 15, but adding formaldehyde (150 ppm) to the feed gas. The samples from Example 15 were cooled down from the second L/O run under a N₂ atmosphere only prior to the light-off experiments. The data are provided in Table 6.

TABLE 6
HC/CO Light-Off (L/O) Temperatures and NO₂ yield at 300° C.

| | | | | NO₂ yield |
|---|---|---|---|---|
| | | HC₇₀ L/O, | CO₃₀ L/O, | at 300° C., |
| State | Example # | ° C. | ° C. | % |
| Fresh | Example 7 (Ref) | 247 | 180 | 4 |
| | Example 8 | 245 | 184 | 40 |
| | Example 9 | 231 | 181 | 81 |
| | Example 10 | 231 | 182 | 90 |
| | Example 11 | 214 | 160 | 59 |
| | Example 12 | 241 | 180 | 46 |
| Aged | Example 7 (Ref) | 288 | 192 | 3 |
| | Example 8 | 261 | 192 | 7 |
| | Example 9 | 251 | 188 | 59 |
| | Example 10 | 250 | 193 | 54 |
| | Example 11 | 260 | 191 | 37 |
| | Example 12 | 255 | 192 | 26 |

As demonstrated by the data in Table 6, a similar trend to that for Example 15 was observed; i.e., all inventive articles show improved HC conversion, fresh or aged, and offered significantly higher NO₂ yield than the Reference article (Example 7). The addition of Mn onto the La-containing zirconia support was beneficial for both HC conversion and NO₂ yield.

### Examples 23-28

Several different supports, other than the Reference B (Example 16) were also evaluated in the powder form. The sample preparation process is similar to Example 2, except that the dopant and support were different. A detailed description of various powder samples in this new set of experiments is listed in Table 7, and all the supports were preformed (commercially available).

TABLE 7
Catalyst articles: 1%; Pt/Pd (Pt/Pd = 2/1), on various supports

| Example # | Single washcoat layer | Support compositions |
|---|---|---|
| 23 | 1% 2:1 Pt/Pd on La/ZrO₂ | La/ZrO₂: about 9% La, |
| (Reference) | | 91% Zr |
| 24 | 1% 2:1 Pt/Pd with 10% | Y/ZrO₂: about 10% Y, |
| | Y on ZrO₂ | 90% Zr |
| 25 | 1% 2:1 Pt/Pd with 10% | Si/ZrO₂: about 10% Si, |
| | Si on ZrO₂ | 90% Zr |
| 26 | 1% 2:1 Pt/Pd with 24% | Mn/ZrO₂: about 24% Mn, |
| | Mn on ZrO₂ | 76% Zr |
| 27 | 1% 2:1 Pt/Pd with 5% | Si/TiO₂: about 5% Si, |
| | Si on TiO₂ | 95% Ti |
| 28 | 1% 2:1 Pt/Pd with 5% | Si/Al₂O₂: about 5% Si, |
| | Si on Al₂O₃ | 95% Al |

The powder sample preparation and testing processes are the same as described in Example 15. The results are listed in Tables 8 to 11.

TABLE 8
HC/CO Light-Off (L/O) Temperatures and NO₂ yield at 300°
C. & 250° C. (fresh & aged samples)

| | | HC₇₀ | CO₃₀ | NO₂ yield | NO₂ yield |
|---|---|---|---|---|---|
| | | L/O, | L/O, | at 300° C., | at 250° C., |
| State | Example # | ° C. | ° C. | % | % |
| Fresh | Example 23 | 230 | 174 | 33.7 | 10.2 |
| | (Ref) | | | | |
| | Example 24 | 225 | 173 | 42.8 | 17.3 |
| Aged | Example 23 | 265 | 213 | 4.4 | 2.0 |
| | (Ref) | | | | |
| | Example 24 | 253 | 200 | 15.4 | 4.8 |

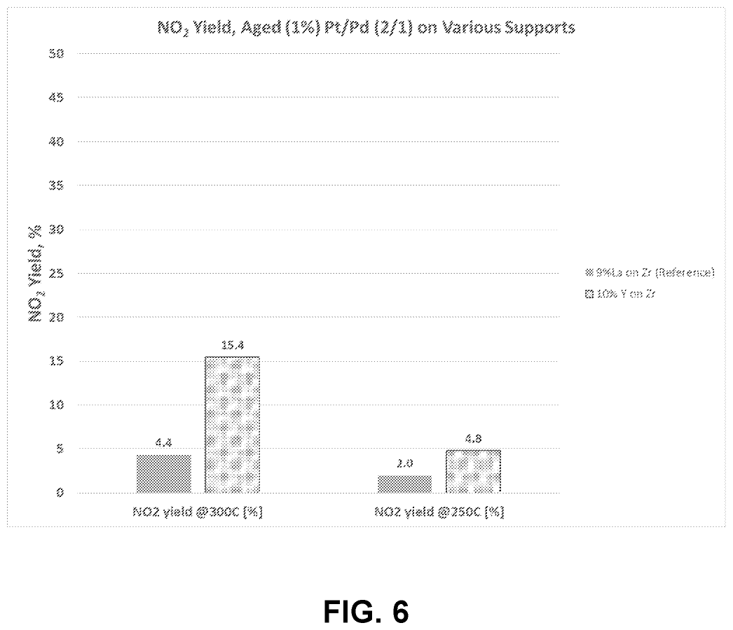

From Table 8 and FIG. 6, the Y on ZrO₂ support (inventive example 24) outperforms the La/ZrO₂ in both CO/HC L/O and NO₂ yield, either fresh or aged samples.

TABLE 9
HC/CO Light-Off (L/O) Temperatures and NO₂ yield at 300°
C. & 250° C. (fresh & aged samples)

| | | HC₇₀ | CO₅₀ | NO₂ yield | NO₂ yield |
|---|---|---|---|---|---|
| | | L/O, | L/O, | at 300° C., | at 250° C., |
| State | Example # | ° C. | ° C. | % | % |
| Fresh | Example 23 | 230 | 174 | 33.7 | 10.2 |
| | (Ref) | | | | |
| | Example 25 | 223 | 175 | 57.0 | 28.2 |
| Aged | Example 23 | 265 | 213 | 4.4 | 2.0 |
| | (Ref) | | | | |
| | Example 25 | 264 | 210 | 9.9 | 2.4 |

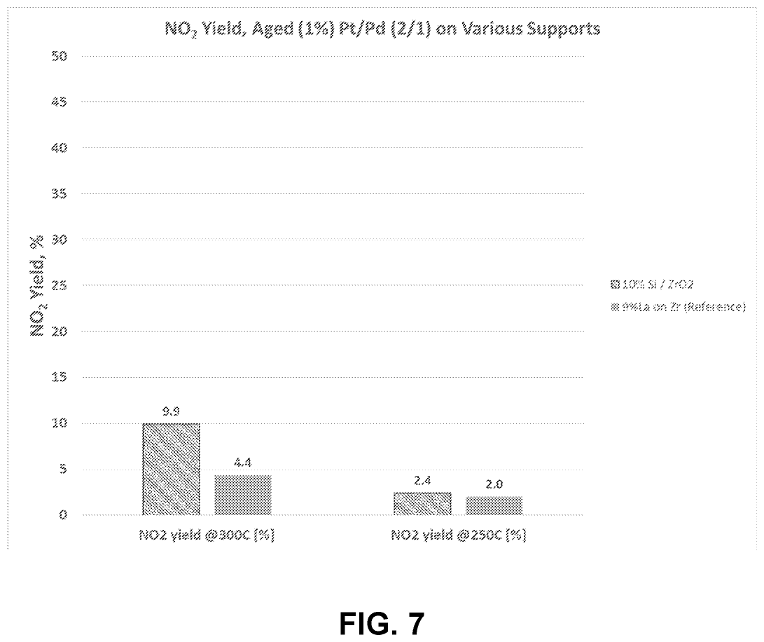

From Table 9 and FIG. 7, the Si on ZrO₂ support (inventive example 25) also outperforms the La/ZrO₂ in both CO/HC L/O and NO₂ yield, either fresh or aged samples.

TABLE 10
HC/CO Light-Off (L/O) Temperatures and NO₂ yield at 300°
C. & 250° C. (fresh & aged samples)

| | | HC₇₀ | CO₅₀ | NO₂ yield | NO₂ yield |
|---|---|---|---|---|---|
| | | L/O, | L/O, | at 300° C., | at 250° C., |
| State | Example # | ° C. | ° C. | % | % |
| Fresh | Example 23 | 230 | 174 | 33.7 | 10.2 |
| | (Ref) | | | | |
| | Example 26 | 222 | 168 | 55.8 | 27.2 |
| Aged | Example 23 | 265 | 213 | 4.4 | 2.0 |
| | (Ref) | | | | |
| | Example 26 | 245 | 208 | 32.0 | 9.3 |

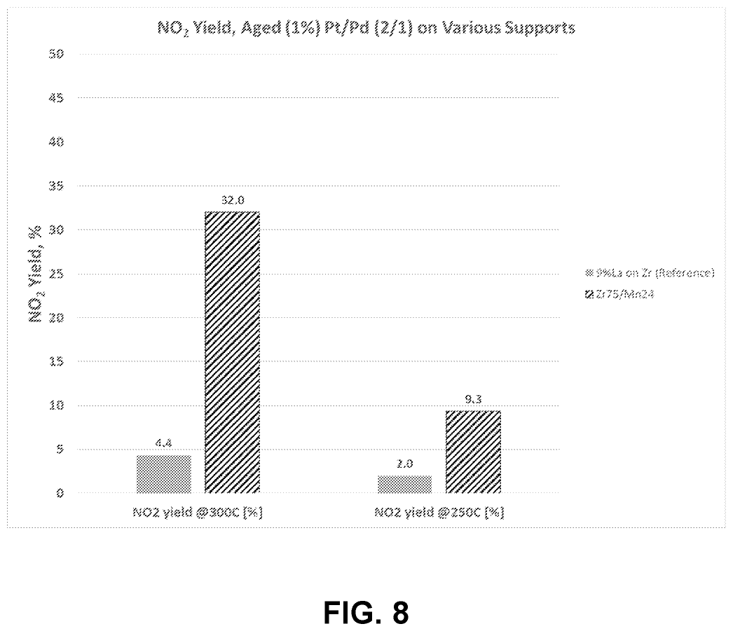

From Table 10 and FIG. 8, the Mn on ZrO₂ support (inventive example 26) outperforms the La/ZrO₂ in both CO/HC L/O and NO₂ yield, and especially in NO₂ yield, either fresh or aged samples. The inventive example 26 sample also provides a very good NO₂ performance stability, between fresh and aged samples.

TABLE 11
HC/CO Light-Off (L/O) Temperatures and NO₂ yield at 300°
C. & 250° C. (fresh & aged samples)

| | | HC₇₀ | CO₅₀ | NO₂ yield | NO₂ yield |
|---|---|---|---|---|---|
| | | L/O, | L/O, | at 300° C., | at 250° C., |
| State | Example # | ° C. | ° C. | % | % |
| Fresh | Example 23 | 230 | 174 | 33.7 | 10.2 |
| | (Ref) | | | | |
| | Example 27 | 215 | 171 | 65.9 | 41.2 |
| Aged | Example 23 | 265 | 213 | 4.4 | 2.0 |
| | (Ref) | | | | |
| | Example 27 | 252 | 208 | 25.2 | 4.6 |

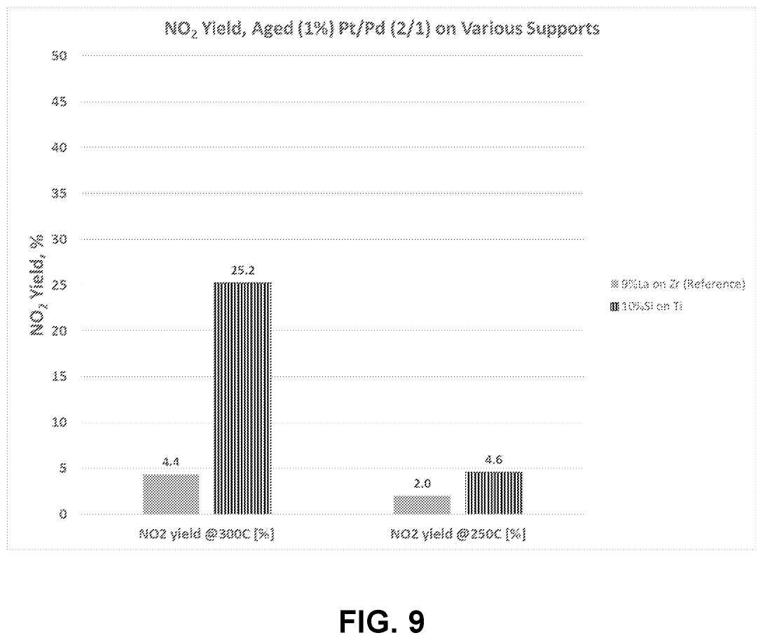

From Table 11 and FIG. 9, the Si on TiO₂ support (inventive example 27) outperforms the La/ZrO₂ in both CO/HC L/O and NO₂ yield as well, and especially in NO₂ yield, either fresh or aged samples.

TABLE 12
HC/CO Light-Off (L/O) Temperatures and NO₂ yield at 300°
C. & 250° C. (fresh & aged samples)

| | | HC₇₀ | CO₅₀ | NO₂ yield | NO₂ yield |
|---|---|---|---|---|---|
| | | L/O, | L/O, | at 300° C., | at 250° C., |
| State | Example # | ° C. | ° C. | % | % |
| Fresh | Example 23 | 230 | 174 | 33.7 | 10.2 |
| | (Ref) | | | | |
| | Example 28 | 224 | 169 | 47.9 | 20.9 |
| Aged | Example 23 | 265 | 213 | 4.4 | 2.0 |
| | (Ref) | | | | |
| | Example 28 | 253 | 199 | 22.0 | 2.4 |

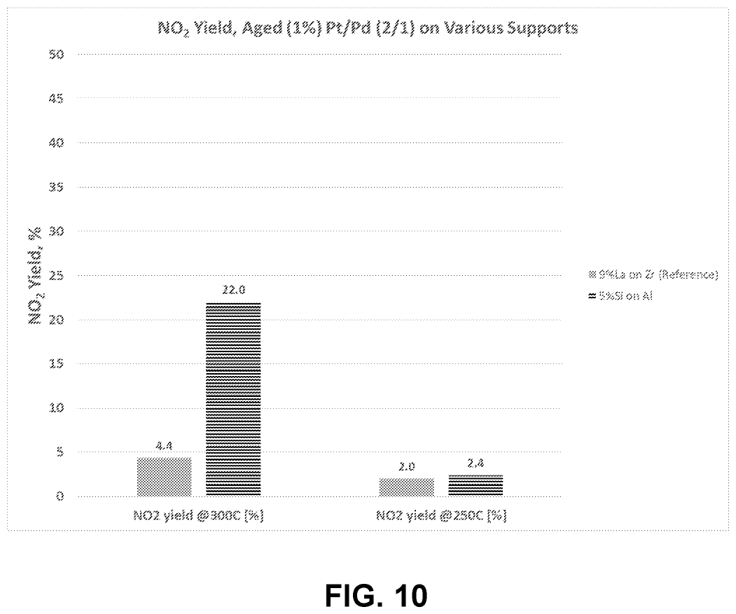

Again, from Table 12 and FIG. 10, the Si on Al₂O₃ support (inventive example 28) outperforms the La/ZrO₂ in both CO/HC L/O and NO₂ yield, either fresh or aged samples.

In addition to the hydrothermal aging, several above samples (fresh, i.e., calcined samples not subjected to aging), were also subjected to sulfation (S) according to the procedures described here:
T=300° C.
Total flow: 1000 liter/hour
Feed gas: 10 ppm SO₂, 10 vol. % O₂, 5 vol. % H₂O, balance nitrogen
Duration: 6 hours
Sulfur exposure: approximate 1 g/per liter of the catalyst

After sulfation, the same catalysts were exposed to the following conditions for sulfur removal: 30 minutes at 700° C. (10% H₂O in air)

After the sulfur removal step (de-S), the catalysts were evaluated again under the same light-off protocol as shown in Table 13.

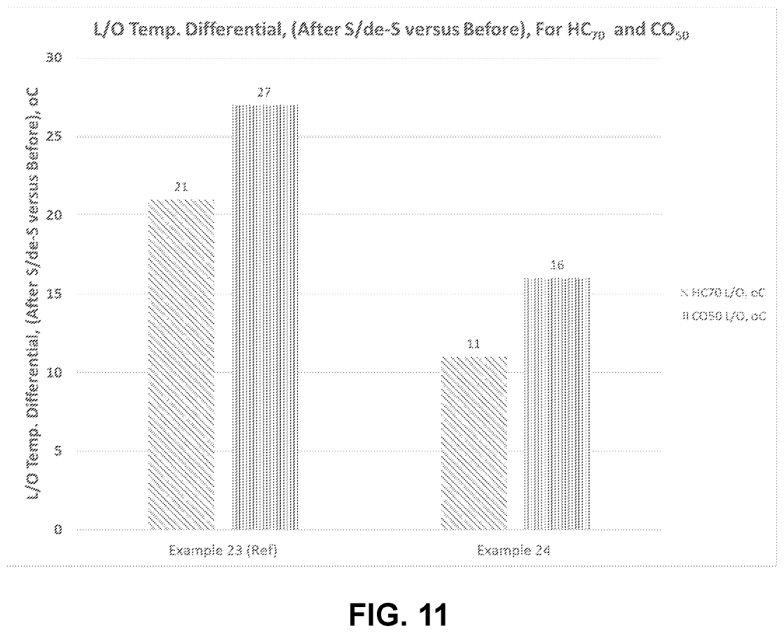

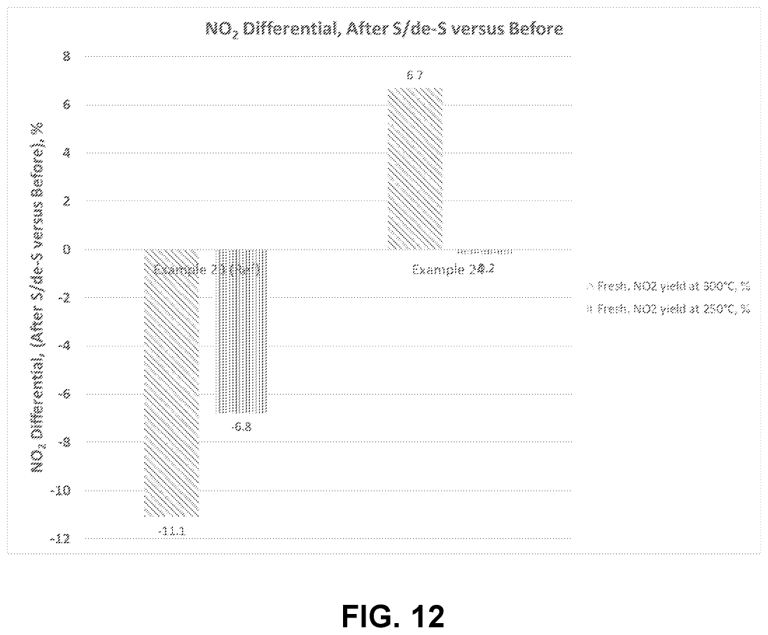

Results, shown in Table 13 and FIGS. 11 and 12, indicate that the inventive Examples 24 to 28 offer a better sulfur resistance than the reference sample Example 23.

TABLE 13
HC/CO Light-Off (L/O) Temperatures and NO₂ yield at 300°
C. & 250° C. (fresh samples, after sulfur exposure
and sulfur removal treatments)

| | | HC₇₀ | CO₅₀ | NO₂ yield | NO₂ yield |
|---|---|---|---|---|---|
| | | L/O, | L/O, | at 300° C., | at 250° C., |
| State | Example # | ° C. | ° C. | % | % |
| Fresh/S | Example 23 | 251 | 201 | 22.6 | 3.4 |
| and de-S | (Ref) | | | | |
| | Example 24 | 236 | 189 | 49.5 | 17.1 |
| | Example 25 | 242 | 197 | 47.8 | 10.7 |
| | Example 26 | 250 | 207 | 37.2 | 10.7 |
| | Example 27 | 238 | 194 | 57.3 | 23.4 |
| | Example 28 | 235 | 184 | 44.8 | 10.4 |

Results from Table 13 show that all the inventive samples (Example 24 to Example 28) offer a better NO₂ performance, either fresh or aged, after the sulfation and sulfur-removal steps. Also, almost all the inventive samples show better HC₇₀ and CO₅₀ light-off performance, indicating that inventive samples are indeed offering performance advantages over the reference Example 23.

In particular, the inventive Example 24, shows the least performance deterioration after sulfation and de-sulfation (sulfur-removal) steps, as shown in FIGS. 11 and 12. The positive impact on NO₂ performance, after sulfation and de-sulfation (sulfur-removal), is a unique feature of this catalyst.

1. An oxidation catalyst composition comprising:
a platinum group metal (PGM) component comprising palladium, platinum, or a combination thereof,
a first oxide chosen from oxides of cerium, silicon, iron, cobalt, zinc, chromium, molybdenum, nickel, tungsten, magnesium, antimony, tin, lead, yttrium, and combinations thereof, and
a first refractory metal oxide support material.

2. The oxidation catalyst composition of claim 1, wherein the first oxide is chosen from oxides of yttrium and silicon.

3. The oxidation catalyst composition of claim 1, comprising the first oxide in an amount by weight, on an oxide basis, from about 1% to about 90%, based on the weight of the first refractory metal oxide support material.

4. The oxidation catalyst composition of claim 1, wherein the first oxide is supported on the first refractory metal oxide support material.

5. The oxidation catalyst composition of claim 1, wherein the first refractory metal oxide support material comprises zirconia, titanium, or aluminum in an amount by weight from about 1% to about 99%, and the first refractory metal oxide support material optionally comprises alumina, silica, ceria, titanium oxide, silica-doped alumina, silica titania, silica-zirconia, yttrium-zirconium, manganese-zirconium, tungsten-titania, zirconia-titania, zirconia-ceria, zirconia-alumina, manganese-alumina, lanthanum-zirconia-alumina, magnesium-alumina oxide, zirconia doped with from about 0.1% to about 40% by weight of lanthana, and combinations thereof.

6. (canceled)

7. The oxidation catalyst composition of claim 1, wherein:
the first oxide is an oxide of ceria, and
the ceria is present in an amount up to about 99% by weight, based on the weight of the first refractory metal oxide support material.

8. The oxidation catalyst composition of claim 1, wherein:
the first oxide is an oxide of yttrium, and
the yttrium is present in an amount up to about 99% by weight, based on the weight of the first refractory metal oxide support material.

9. The oxidation catalyst composition of claim 1, wherein:
the first oxide is an oxide of silicon, and
the silicon is present in an amount up to about 99% by weight, based on the weight of the first refractory metal oxide support material.

10. The oxidation catalyst composition of claim 1, wherein:
the palladium is loaded on the first refractory metal oxide support in an amount by weight from about 0% to about 10%, based on the weight of the first refractory metal oxide support;
the platinum is loaded on the first refractory metal oxide support in an amount by weight from about 0% to about 10%, based on the weight of the first refractory metal oxide support; and
wherein at least one of the platinum or the palladium is present in an amount by weight of about 0.1% or greater, based on the weight of the first refractory metal oxide support material.

11. The oxidation catalyst composition of claim 1, wherein the PGM component comprises a combination of platinum and palladium.

12. The oxidation catalyst composition of claim 11, wherein a ratio of palladium to platinum by weight is from about 100 to about 0.01 or from about 1 to about 0.01.

13. (canceled)

14. The oxidation catalyst composition of claim 1, further comprising a second refractory metal oxide support material, wherein the second refractory metal oxide support material optionally comprises alumina, silica, zirconia, titania, ceria, silica-doped alumina, silica-titania, silica-zirconia, yttrium-zirconium, manganese-zirconium, tungsten-titania, zirconia-titania, zirconia-ceria, zirconia-alumina, manganese-alumina, lanthanum-zirconia, lanthanum-zirconia-alumina, magnesium-alumina oxide, or a combination thereof and the second refractory metal oxide support material optionally comprises a base metal oxide chosen from oxides of cerium, iron, cobalt, zinc, chromium, molybdenum, nickel, tungsten, copper, magnesium, antimony, tin, lead, yttrium, and combinations thereof.

15. (canceled)

16. (canceled)

17. The oxidation catalyst composition of claim 14, wherein the PGM component is supported on the second refractory metal oxide support material in an amount by weight from about 0.1% to about 10%, based on the weight of the second refractory metal oxide support material.

18. The oxidation catalyst composition of claim 14, wherein the second refractory metal oxide support material comprises alumina or zirconia, and the zirconia in the second refractory metal oxide support material is optionally doped with lanthanum in an amount by weight from about 0.1% to about 40%, on an oxide basis, based on the weight of the zirconia.

19. (canceled)

20. The oxidation catalyst composition of claim 14, wherein the first oxide is supported on the first refractory metal oxide support material, and the PGM component is supported on the second refractory metal oxide support material, wherein the PGM component is supported on the second refractory metal oxide support material optionally in an amount from about 0.1% to about 10% by weight, based on the weight of the second refractory metal oxide support material.

21. (canceled)

22. The oxidation catalyst composition of claim 14, wherein:
the first oxide is supported on the first refractory metal oxide support material in an amount by weight, on an oxide basis, from about 1% to about 40%, based on the weight of the first refractory metal oxide support material; and
the PGM component is supported on the second refractory metal oxide support material, wherein the second refractory metal oxide support material is chosen from alumina, silica-doped alumina, titania, titania-doped alumina, zirconium doped alumina, zirconia, and zirconia doped with from about 0.1% to about 40% by weight of lanthana, based on the weight of the zirconia.

23. The oxidation catalyst composition of claim 22, wherein the first oxide is chosen from oxides of yttrium and silicon.

24. The oxidation catalyst composition of claim 22, wherein the first refractory metal oxide support material comprises ceria in an amount by weight from about 1% to about 50%, based on the weight of the first refractory metal oxide support material.

25. The oxidation catalyst composition of claim 1, wherein the oxidation catalyst composition is substantially free of copper.

26. A catalytic article comprising a substrate having an inlet end and an outlet end defining an overall length, and a catalytic coating disposed on at least a portion thereof, the catalytic coating comprising a first washcoat and a second washcoat, wherein:
the first washcoat comprises a first oxide and a first refractory metal oxide support material, wherein the first oxide is chosen from oxides of cerium, silicon, iron, cobalt, zinc, chromium, molybdenum, nickel, tungsten, magnesium, antimony, tin, lead, yttrium, and combinations thereof, and the first oxide is supported on the first refractory metal oxide support material; and
the second washcoat comprises a platinum group metal (PGM) component comprising palladium, platinum, or a combination thereof, and a second refractory metal oxide support material, wherein the PGM component is supported on the second refractory metal oxide support material.

27.-48. (canceled)

49. A catalytic article comprising a substrate having an inlet end and an outlet end defining an overall length, and a catalytic coating disposed on at least a portion thereof, the catalytic coating comprising a first washcoat, a second washcoat, and a third washcoat, wherein:
the first washcoat comprises a first oxide and a first refractory metal oxide support material, wherein the first oxide is chosen from oxides of yttrium and silicon, and the first oxide is supported on the first refractory metal oxide support material;
the second washcoat comprises a base metal oxide component comprising ceria, zirconia, lanthanum oxide, copper oxide, or a combination thereof, and a second refractory metal oxide support material, wherein the base metal oxide component is supported on the second refractory metal oxide support material; and
the third washcoat comprises a platinum group metal (PGM) component comprising palladium, platinum, or a combination thereof, and a third refractory metal oxide support material, wherein the PGM component is supported on the third refractory metal oxide support material.

50.-67. (canceled)
